(19) United States
(12) Patent Application Publication
(10) Pub. No.: US 2018/0309995 A1
(43) Pub. Date: Oct. 25, 2018

(54) HIGH DYNAMIC RANGE VIDEO CODING

(71) Applicant: Vid Scale, Inc., Wilmington, DE (US)

(72) Inventors: Yuwen He, San Diego, CA (US); Yan Ye, San Diego, CA (US); Louis Kerofsky, San Diego, CA (US); Arash Vosoughi, San Jose, CA (US); Ralph Neff, San Diego, CA (US)

(73) Assignee: Vid Scale, Inc., Wilmington, DE (US)

(21) Appl. No.: 15/565,276

(22) PCT Filed: Apr. 21, 2016
(86) PCT No.: PCT/US2016/028678

§ 371 Date: Oct. 9, 2017

Related U.S. Application Data
(60) Provisional application No. 62/150,807, filed on Apr. 21, 2015.
(60) Provisional application No. 62/252,146, filed on Nov. 6, 2015.
(60) Provisional application No. 62/291,710, filed on Feb. 5, 2016.

(51) Int. Cl. H04N 19/126; H04N 19/14; H04N 19/98; H04N 19/31; H04N 19/82; H04N 19/105; H04N 19/186

(52) U.S. Cl. CPC H04N 19/126; H04N 19/14; H04N 19/98; H04N 19/186; H04N 19/82; H04N 19/105; H04N 19/31

(57) ABSTRACT

A video sequence may include a first-temporal level picture and a second-temporal level picture. The first-temporal level picture may be associated with a first temporal level, and the second-temporal level picture may be associated with a second temporal level. The second-temporal level picture may reference the first-temporal level picture. A first chroma quantization parameter (QP) may be determined based on a temporal level of the first-temporal level picture. A second chroma QP may be determined based on a temporal level of the second-temporal level picture. The first-temporal level picture may be encoded based on the first chroma QP to the first-temporal level picture and/or the second-temporal level picture may be encoded based on the second chroma QP to the second-temporal level picture. The first chroma QP may be different than the second chroma QP.

### CROSS-REFERENCE TO RELATED APPLICATIONS

This application claims priority to U.S. Provisional Patent Application Ser. No. 62/150,807, filed Apr. 21, 2015, U.S. Provisional Patent Application Ser. No. 62/252,146, filed Nov. 6, 2015, and U.S. Provisional Patent Application Ser. No. 62/291,710, filed Feb. 5, 2016, each of which are incorporated herein by reference in their entireties.

### BACKGROUND

Video coding systems may be used to compress digital video signals, for instance, to reduce storage space consumed and/or to reduce transmission bandwidth consumption associated with such signals. Examples of various types of video coding systems may include block-based, wavelet-based, and/or object-based systems.

Various digital video compression technologies may have been developed and standardized to enable efficient digital video communication, distribution, and consumption. Examples of block-based video coding systems may include international video coding standards, such as the MPEG1/2/4 part 2, H.264/MPEG-4 part 10 AVC, VC-1, and the H.265/HEVC (High Efficiency Video Coding) standard.

High Dynamic Range (HDR) video coding may use the same or higher bit-depth compared to that in Standard Dynamic Range (SDR) video coding. The dynamic range of the color components for HDR video may be larger than that for SDR video. In HDR coding, the dynamic range of chroma may be increased, and the number of bits used for chroma components may be increased. In bright scenes, chroma related artifacts (such as, for example, color bleeding and local hue changes) may be observed easily. HDR video sequences may have some different characteristics compared to SDR video sequences.

### SUMMARY

Systems, methods, and instrumentalities may be disclosed for encoding a video sequence. The video sequence may include a first-temporal level picture and/or a second-temporal level picture. The first-temporal level picture may be associated with a first temporal level, and/or the second-temporal level picture may be associated with a second temporal level. The second-temporal level picture may reference the first-temporal level picture.

A first chroma quantization parameter (QP) to the first-temporal level picture may be determined. The first chroma QP parameter may be determined based on a temporal level of the first-temporal level picture. A second chroma QP to the second-temporal level picture may be determined. The second chroma QP parameter may be determined based on a temporal level of the second-temporal level picture. The first-temporal level picture may be encoded based on the first chroma QP to the first-temporal level picture and/or the second-temporal level picture may be encoded based on the second chroma QP to the second-temporal level picture. The first chroma QP may be different than the second chroma QP. For example, the first chroma QP may be smaller than the second chroma QP.

A chroma activity parameter may be calculated to measure a chroma energy associated with the first-temporal level picture. If the chroma activity is smaller than a predetermined chroma activity threshold, the first chroma QP may not be adjusted. A chroma activity parameter may be calculated to measure a chroma energy associated with the second-temporal level picture. If the chroma activity is smaller than a predetermined chroma activity threshold, the second chroma QP may not be adjusted. The chroma activity parameter may be the same for the first and second temporal level pictures, and/or the chroma activity parameter may be different for the first and second temporal level pictures.

Deblocking parameters may be searched and selected for a picture. A first deblocking parameter (“beta”) value may be identified. The beta value may be used to determine if deblocking filtering is to be performed. A second parameter (“t_{C}”) value may be identified. The t_{C} value may be used to determine an amplitude of a deblocking filter. A previous distortion parameter and/or a second previous distortion parameter may be identified.

A distortion associated with using the beta value and/or the t_{C} value for performing deblocking filtering may be calculated. The previous distortion may be compared with the second previous distortion. If the previous distortion is greater than the second previous distortion, the beta value and/or the t_{C} value may be signaled. For example, if the previous distortion is greater than the second previous distortion, the beta value and/or the t_{C} value may be signaled as the deblocking parameters for the picture. If the previous distortion is less than the second previous distortion, a next beta value and/or a next t_{C} value may be identified, and/or a next distortion may be calculated. The next distortion may be associated with using the next beta value and/or the next t_{C} value for performing deblocking filtering.

### BRIEF DESCRIPTION OF THE DRAWINGS

FIG. 1 shows a block diagram illustrating an example block-based video encoder.

FIG. 2 shows a block diagram illustrating an example block-based video decoder.

FIG. 3 shows a diagram of an example of prediction unit modes in HEVC (High Efficiency Video Coding).

FIG. 4 shows a diagram of an example of scalar quantization with a dead zone.

FIG. 5 shows a diagram of an example of color gamut in High Definition (HD) and Ultra High Definition (UHD) video formats.

FIG. 6 shows a diagram of an example of 3D color volume, with the (x,y) plane corresponding to the CIE 1931 color space in FIG. 5, and the vertical Y axis corresponding to the luminance (e.g. brightness) signal.

FIG. 7 shows a diagram of an example of illustrating the mapping between linear light to code level of SDR video and HDR video.

FIG. 8 shows a diagram of an example of a workflow for HDR coding/decoding.

FIG. 9 shows a diagram of an example of hierarchical video coding structure.

FIG. 10 shows a diagram of an example of HDR test sequences that are predominately dark (top) and predominately bright (bottom).

FIG. 11 shows a diagram of an example of a chroma activity calculation.

FIG. 12 shows a diagram of an example of global illumination for a HDR test sequence.

FIG. 13 shows a diagram of an example of a Gaussian distribution fitting for a histogram.

FIG. 14 shows a diagram of an example of a flowchart of a fast block parameter search with early termination.

FIG. 15 shows a diagram of an example of using an integral of a histogram of a scene as the reshaping function.

FIG. 16 shows a diagram of an example of using an integral of a histogram above a threshold as the reshaping function.

FIG. 17 shows a diagram of an example of partitioning a picture into multiple regions.

FIG. 18 shows a diagram of an example of using a nonlinear reshaping function.

FIG. 19 shows a diagram of an example of loss of image detail due to veiling glare.

FIG. 20 shows a diagram of an example of a dual layer liquid crystal display (LCD) for producing an HDR display.

FIG. 21 is a diagram of an example of using a glare model which may be used to preprocess HDR video for compression.

FIG. 22 is a diagram of an example of a Gaussian filter for modeling a glare point spread function.

FIG. 23 is a diagram of an example of convolution of a modeled glare point spread function with image luminance.

FIG. 24 is a diagram of an example of filter cut off frequency versus relative glare strength.

FIG. 25A depicts a system diagram of an example communications system in which one or more disclosed embodiments may be implemented.

FIG. 25B depicts a system diagram of an example wireless transmit/receive unit (WTRU) that may be used within the communications system depicted in FIG. 25A.

FIG. 25C depicts a system diagram of an example radio access network and an example core network that may be used within the communications system depicted in FIG. 25A.

FIG. 25D depicts a system diagram of an example radio access network and an example core network that may be used within the communications system depicted in FIG. 25A.

FIG. 25E depicts a system diagram of an example radio access network and an example core network that may be used within the communications system depicted in FIG. 25A.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate one or more message charts, which are meant to be exemplary. Other embodiments may be used. The order of the messages may be varied where appropriate. Messages may be omitted if not needed, and, additional messages may be added.

Video may be consumed on devices with varying capabilities in terms of computing power, memory storage size, display resolution, display frame rate, etc. For example, video may be consumed on by smart phones and/or tablets. Network and/or transmission channels may have varying characteristics in terms of packet loss rate, available channel bandwidth, burst error rate, end-to-end delay, etc. Video data may be transmitted over a combination of wired networks and/or wireless networks, which may complicate one or more underlying video transmission channel characteristics. In such scenarios, scalable video coding may improve a video quality provided by video applications, for example, video quality provided by video applications running on devices with different capabilities over heterogeneous networks.

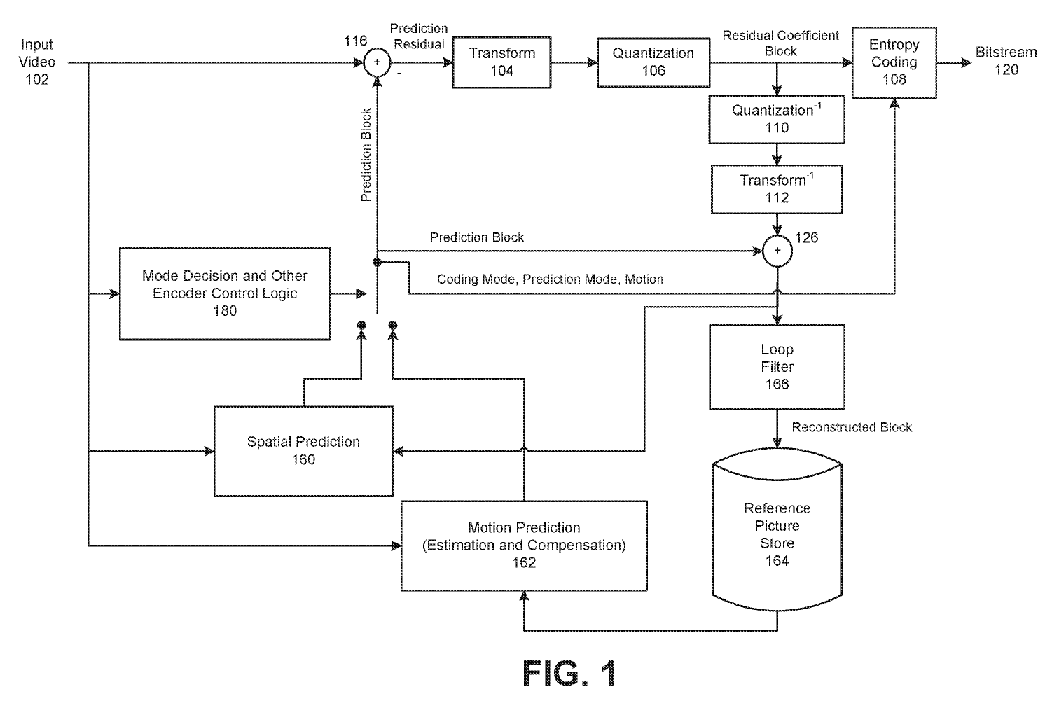

FIG. 1 shows an example of a block-based hybrid video encoding system. An input video signal 102 is processed block by block. A video block unit may include 16×16 luma samples and corresponding chroma samples. The number of chroma samples may depend on the chroma format of the input video signal. For example, if 4:2:0 subsampling is used, then two 8×8 chroma blocks may correspond with one 16×16 block of luma samples. Such a basic coding block unit may be referred to as a macroblock or MB (for example, in earlier standards). Extended block sizes (e.g., a “coding tree unit” or CTU) may be used to compress high resolution (e.g., 1080p and beyond) video signals. A CTU may have various sizes, including 64×64, 32×32, and 16×16 (in terms of luma samples). The CTU size may be selected at the sequence level and/or signaled in the Sequence Parameter Set (SPS). A CTU may be partitioned into coding units (CU) via quad-tree splitting. At the CU level, intra and/or inter prediction mode may be selected.

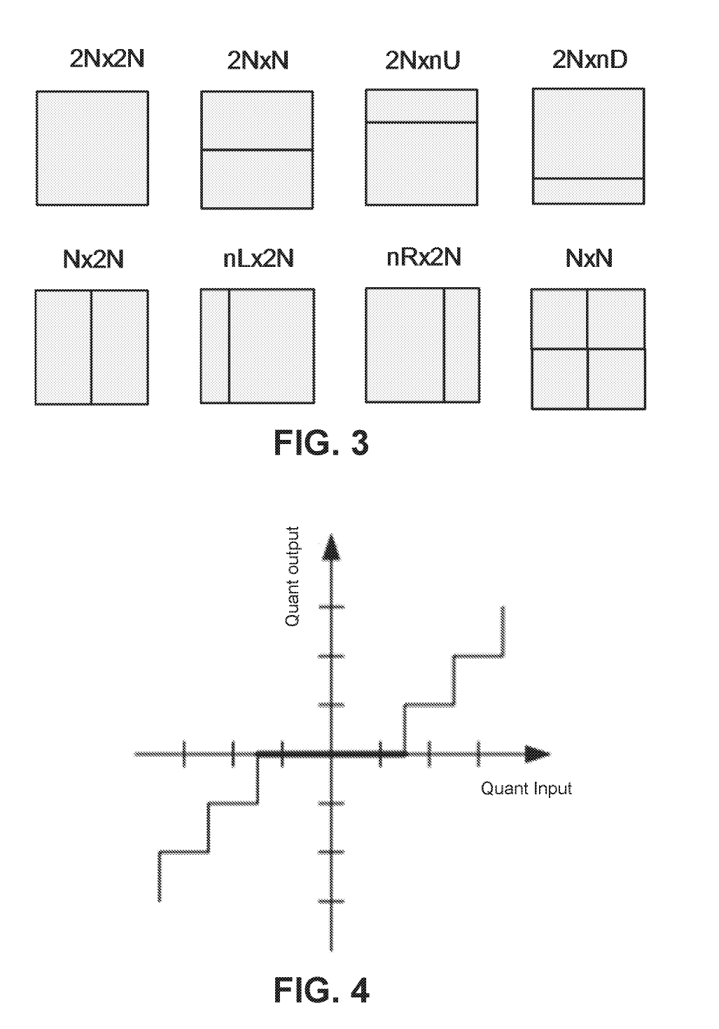

A (e.g., each) CU may be partitioned into prediction units (PU), to which separate prediction may be applied. Different PU partitions of a CU are shown in FIG. 3. For an input video block (e.g., MB or CU), spatial prediction 160 and/or temporal prediction 162 may be performed. Spatial prediction (e.g., “intra prediction”) may use pixels from already coded neighboring blocks in the same video picture and/or slice (e.g., to predict a current video block). Spatial prediction may reduce spatial redundancy inherent in the video signal. Temporal prediction (e.g., “inter prediction” or “motion compensated prediction”) may use pixels from already coded video pictures (e.g., to predict a current video block). Temporal prediction may reduce temporal redundancy inherent in the video signal. Temporal prediction for a given video block may be signaled by one or more motion vectors and/or one or more reference indices. The motion vectors may indicate the amount and/or the direction of motion between the current block and/or its reference block. The reference indices may identify from which reference pictures in the decoded picture buffer (such as “reference picture store 164” shown in FIG. 1) the one or more temporal prediction blocks may come.

After spatial and/or temporal prediction, the mode decision block 180 in the encoder may choose the best prediction mode. For example, the mode decision block 180 in the encoder may choose an intra prediction mode and/or an inter prediction mode). The mode decision block 180 in the encoder may choose prediction information (e.g., associated prediction information). For example, the mode decision block 180 in the encoder may choose luma and/or chroma prediction mode if intra coded. The mode decision block 180 in the encoder may choose motion partitions, motion vectors, and/or reference indices if inter coded. Modern encoder mode decision logic may rely on a rate-distortion optimization method to choose the best mode that may provide an optimal trade-off between distortion (e.g., Mean Squared Error between the reconstructed video block and the original video block) and rate (e.g., number of bits spent coding the block).

A prediction block may be subtracted from the current video block 116. The prediction residual may be transformed 104 and/or quantized 106. Transform skip mode may be performed at the Transform Unit (TU) level, which may bypass the transform stage and/or directly quantize the prediction residuals of a TU block in the spatial domain. The quantized residual coefficients may be inverse quantized 110 and/or inverse transformed 112 (e.g., if transform skip mode is not applied) to form the reconstructed residual, which may be added back to the prediction block 126 to form the reconstructed video block. Further in-loop filtering may be applied at 166 on the reconstructed video block before it is put in the reference picture store 164 and/or used to code future video blocks.

Deblocking filters may be adaptive smoothing filters applied on block boundaries to reduce the blocking artifacts due to different modes and/or parameters used to code two neighboring blocks. A non-linear in-loop filter may be referred to as Sample Adaptive Offsets (SAO). There may be two types of SAO filtering: Band Offsets (SAO-BO), which may be used (e.g., may primarily be used) to reduce banding artifacts, and/or Edge Offsets (SAO-EO) which may be used (e.g., may primarily be used) to restore edges (which may be distorted more severely due to quantization). An in-loop filtering, such as Adaptive Loop Filters (ALF), may be used.

To form the output video bitstream 120, coding mode (e.g., inter or intra), prediction mode information, motion information (e.g., motion vectors and/or reference indices), quantized residual coefficients, and/or in-loop filtering parameters (e.g. SAO-EO and/or SAO-BO parameters) may be sent to the entropy coding unit 108 to be further compressed and/or packed to form the bitstream.

Quantization 106 may introduce distortion during compression. Codecs (e.g., standardized codecs) may use scalar quantization with a dead-zone, as depicted in FIG. 4. The dead-zone may be used to suppress transform coefficients and/or prediction residuals in the spatial domain with small magnitude. Different sizes of the dead zone may be used depending on the coding mode. Input signal to the quantization process within a certain range may be quantized to have the same value of quantization output (e.g., input values within the dead zone may have quantized output value equal to 0). Quantization process may introduce distortion and/or may reduce (e.g., significantly reduce) the number of bits to code (e.g., required to code) the video. The amount of distortion introduced during quantization may depend on the size of dead-zone and/or the quantization step size.

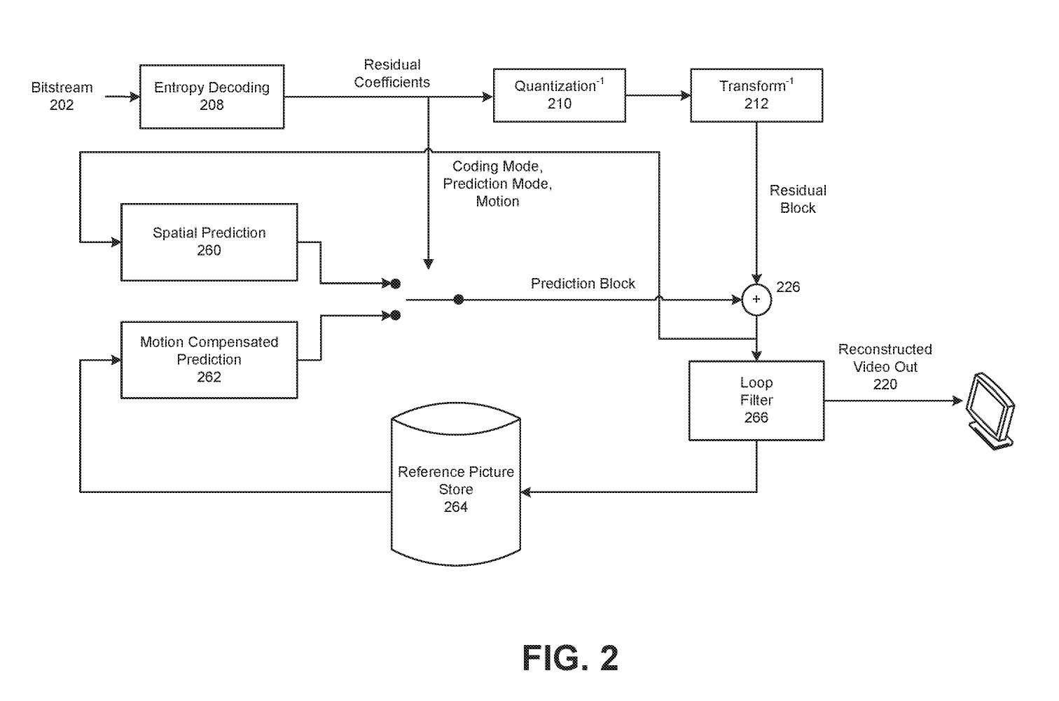

FIG. 2 shows an example of a block-based hybrid video decoder that may correspond to the encoder in FIG. 1. The video bitstream 202 may be unpacked and/or entropy decoded at 208. The coding mode and/or associated prediction information may be sent to spatial prediction 260 (e.g., if intra coded) and/or temporal prediction 262 (e.g., if inter coded) to form the prediction block. The residual transform coefficients may be sent to inverse quantization 210 and/or inverse transform 212 to reconstruct the residual block. The prediction block and/or the reconstructed residual block may be added together at 226 to form the reconstructed block. The reconstructed block may go through in-loop filtering 266 before it may be stored in reference picture store 264. In-loop filtering parameters (e.g. SAO-EO and/or SAO-BO parameters) may be parsed from the bitstream and/or sent to the in-loop filtering unit to control loop filtering operations. The reconstructed video in reference picture store may be sent to drive a display device and/or may be used to predict future video blocks.

For example, bi-prediction may be performed as a form of temporal prediction. Multiple reference pictures and/or deblocking filters may have been used, and/or flexible block structures and/or SAO may have been introduced.

Due to the technological advances in wired and/or wireless network capacities, smartphones, tablets, and/or other portable devices have transformed life with increasing computing capabilities and/or faster network connections. These trends, together with the advancement in video compression technologies, may have led to the ubiquitous presence of High Definition (HD) video across different market segments. Traditional linear TV programs, TV broadcasting, subscription-based or ad-supported on-demand video streaming services (such as those provided by Netflix, Hulu. Amazon, Google's YouTube, etc), live streaming, and/or mobile video applications (e.g., user generated content, video recording, playback, video chats) may offer high quality video in HD format.

The quest for improved video quality may continue beyond HD. Ultra High Definition (UHD) video format may have attracted commercial interest as the service providers looked beyond HD to provide next generation video services promising improved picture quality to the consumer. Industry trends may indicate that consumer uptake of UHD video technology may be on the horizon. There may be significant interest in purchasing UHD displays (e.g., 4K TVs). Many consumers may be willing to pay more for a faster home connection (e.g., wired) and/or wireless connection in order to be able to watch better quality video (e.g., to watch better quality video anywhere, anytime).

UHD video format may be defined in the Recommendation ITU-R BT.2020 and SMPTE ST 2036-1. UHD formats may define parameters in one or more aspects of a video signal. A comparison between the HD and UHD video parameters is provided in Table 1. UHD may support higher spatial resolutions (e.g., 3840×2160 and/or 7680×4320 image samples), higher frame rates (e.g., up to 120 Hz), higher sample bit depths (e.g., up to 12 bits) for high dynamic range support, and/or a wider color gamut that enables the rendering of more vivid colors.

TABLE 1

| | | | Ultra High |
|---|---|---|---|
| | | High Definition | Definition |
| ITU-R BT series | | BT.709-5 (part 2) | BT.2020 |
| Spatial | | 1920 × 1080 | 7680 × 4320, |
| | | | 3840 × 2160 |
| Temporal | Frame rate | 60, 50, 30, 25, 24 | 120, 60, 50, 30, |
| | | | 25, 24 |
| | Scan | Progressive, | Progressive |
| | | interlaced | |
| Primary colors | Red primary | (0.640, 0.300) | (0.708, 0.292) |
| | Green primary | (0.150, 0.330) | (0.170, 0.797) |
| | Blue primary | (0.600, 0.060) | (0.131, 0.046) |

| | |
|---|---|
| White point | (0.3127, 0.3290) (D65) |

| | | |
|---|---|---|
| Coding format | 8- and 10-bit | 10- and 12-bit |

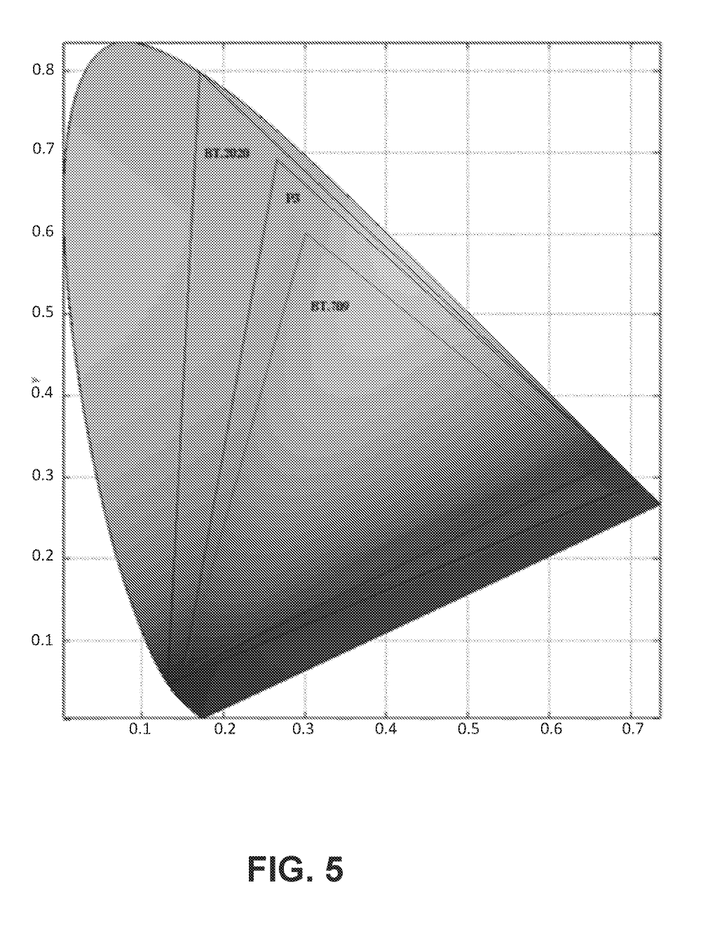

FIG. 5 shows an example of the HD color gamut (e.g., inner triangle) and the UHD color gamut (e.g., outer triangle) overlaid with the CIE 1931 color space chromaticity diagram (e.g., horseshoe shape). The horseshoe shape may represent the range of visible colors to human eyes. The BT.709 color gamut and the BT.2020 color gamut may cover about 36% and 76% of the CIE 1931 color space, respectively. Compared to the color volume that may be reproduced on a BT.709 (HD) display that has dominated the consumer display market for many years, the upcoming BT.2020 displays may increase (e.g, significantly increase) the volume of reproducible colors and/or may be able to bring more (e.g., much more) vivid and/or richer colors to the consumer. Another color gamut may be the P3 color gamut, which may be used in digital cinema applications.

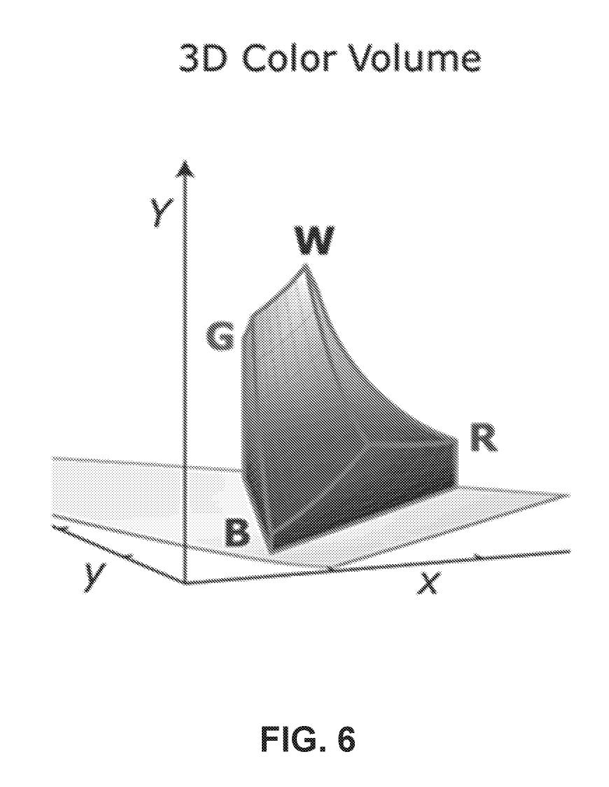

FIG. 6 shows an example of 3D color volume, with the (x,y) plane corresponding to the CIE 1931 color space in FIG. 5, and/or the vertical Y axis corresponding to the luminance (e.g. brightness) signal. The luminance signal may be measured in cd/m2 (candela per square meter), which may be referred to as nits (e.g., 1 nit=1 cd/m2). Dynamic range may be the range of the luminance signal perceived and/or captured in a scene (e.g, a real scene) and/or a rendering device. Dynamic range may be measured in terms of “f-stop” (e.g., “f-number”), where one f-stop may correspond to a doubling of the signal's dynamic range.

Certain consumer displays may only support 100 nits peak luminance. High Dynamic Range (HDR) displays (e.g., with peak luminance of 1000 to 4000 nits) may provide perceptual quality benefits (e.g., significant perceptual quality benefits). Supporting HDR may require changes, including capturing, content creation workflow, delivery, and/or display. The industry may have started to prepare for HDR deployment to the consumer, e.g., due to quality benefits offered by HDR video (e.g., Dolby Vision). HDR signal carried in the 10-bit Y′CbCr format may be compressed using BT.2020 container. On the display side, various vendors are interested in HDR displays.

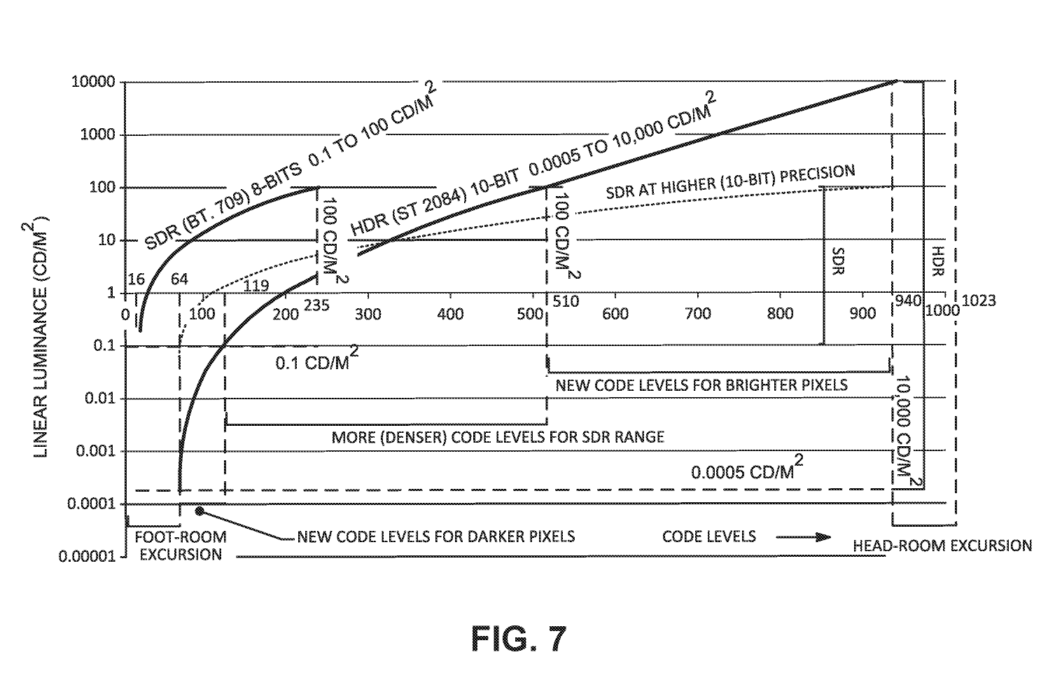

HDR may correspond to one or more f-stops (e.g., more than 16 f-stops). Levels in between 10 and 16 f-stops may be considered as ‘Intermediate’ and/or ‘Extended’ dynamic range. The intent of HDR video may be to offer a wider dynamic range, closer to the capacities of a human's vision. HDR sequences (e.g., native test sequences) may cover BT.709, P3 color gamuts, they may be stored in BT.2020 and/or BT.709 containers, and/or the file format may be EXR and/or TIFF. The peak luminance of the test sequences may be about 4000 nits. The transfer function (TF) used to convert from linear signal to non-linear signal for compression may be perceptual quantizer (PQ) shown in FIG. 7, which may be different from the gamma function used in SDR coding, such as HDTV.

The objective quality evaluation for HDR compression may be complex (e.g., more complex than SDR). For example, the objective quality evaluation for HDR compression may be more complex than SDR because there may be different types of distortions in HDR compressed video (e.g., color bleeding, color banding, and/or typical distortions, such as blurring, blocking, and/or ringing artifacts). The artifacts may be visible (e.g., more visible with bright background). The following metrics may be considered for objective quality evaluation: PSNR in XYZ with the transfer function referred as tPSNR, PSNR evaluation in linear RGB with gamma being set equal to 2.2 referred as mPSNR, PSNR of the mean absolute value of the deltaE2000 metric referred as PSNR_DE2000, Visual Difference Predictor (VDP2). Visual Information Fidelity (VIF), and/or Structural similarity (SSIM).

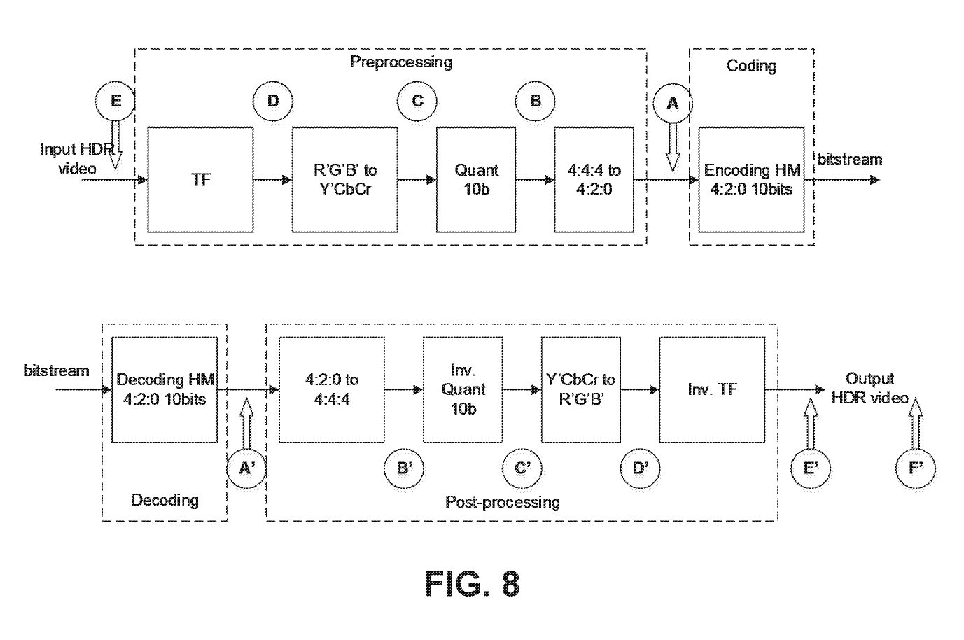

A workflow for HDR coding/decoding is shown in FIG. 8. The workflow may involve one or more kinds of processes. A process may include preprocessing to convert linear signal (e.g. linear floating point RGB) to the signal for compression (e.g. 10-bit YCbCr) including linear to non-linear with TF (e.g. linear RGB to non-linear RGB), color space conversion (e.g. RGB to YCbCr), floating point to fixed point conversion (e.g. quantizing sample value in floating point to 10-bit fixed point), and/or chroma format conversion (e.g. chroma 4:4:4 to 4:2:0). A process may include compression/decompression with single layer codec (e.g. HEVC Main-10 codec) and/or scalable codec (e.g. SHVC Scalable Main-10 codec). A process may include post-processing, e.g., to convert decompressed signal to linear signal (e.g. linear floating point RGB) that may include inverse chroma format conversion (e.g., chroma 4:2:0 to 4:4:4), inverse conversion from fixed point to floating point (e.g. 10-bit fixed point to floating point), inverse color space conversion (e.g. YCbCr to RGB), and/or conversion from non-linear to linear with inverse TF. The procedure for performance evaluation may be different from previous SDR workflows. The evaluation of HDR coding may be performed between E and E′ point at various bitrates.

Additional distortion may be introduced in those processes before compression and/or after decompression. The workflow may involve one or more format conversions (e.g. linear to non-linear, one color space to another, one chroma format to another, sample value range conversion, etc.). Objective quality metrics calculation (e.g. tPSNR, mPSNR, PSNR_DE2000) may take one or more of these processes into consideration. A conversion and/or metrics calculation tool may make the compression and/or evaluation process feasible. The objective metric calculation result may depend on the platform where it may be executed. For example, the objective metric calculation result may depend on the platform where it may be executed because floating point calculation may be used. In the HDR workflow, some related information (e.g., the transfer function, color space, and/or tone mapping related information) may be signaled.

One or more tools defined in HEVC may be related to HDR and/or WCG. The one or more tools defined in HEVC may include one or more video signal type related syntax elements defined in VUI, a tone mapping information SEI message, a mastering display color volume SEI message, a color remapping information SEI message, a knee function information SEI message, and/or a color gamut scalability (CGS)/bit depth scalability (BDS) look-up table in Picture Parameter Set.

The one or more video signal type related syntax elements defined in VUI may include “video_full_range_flag,” “color_primaries,” “transfer_characteristics,” and/or “matrix_coeffs.” The one or more video signal type related syntax elements defined in VUI may define one or more properties of the coded video container (e.g., sample value range, color primaries, transfer function, color space, and/or the like) to map video sample code levels to display intensities.

The tone mapping information SEI message may include one or more methods to transmit one or more curves within a bitstream. Each of the one or more curves may target a different mapping scenario. The tone mapping information SEI message may enable remapping of one or more color samples of output decoded pictures (e.g., for customization to particular display environments).

The mastering display color volume SEI message may signal information of a display monitor used during grading of video content. The signaled information may include a brightness range, one or more color primaries, and/or a white point.

The color remapping information SEI message may be configured to enable remapping of one or more reconstructed color samples of the output pictures.

The knee function information SEI message may be configured to enable mapping of one or more color samples of decoded pictures (e.g., for customization to particular display environments). A knee function may include a piecewise linear function.

The CGS/BDS look-up table in Picture Parameter Set may include defining color mapping between a base layer and a SHVC enhancement layer (e.g., from BT.709 base layer to BT.2020 enhancement layer). The CGS/BDS look-up table in Picture Parameter Set may enable bit depth and/or color gamut scalability.

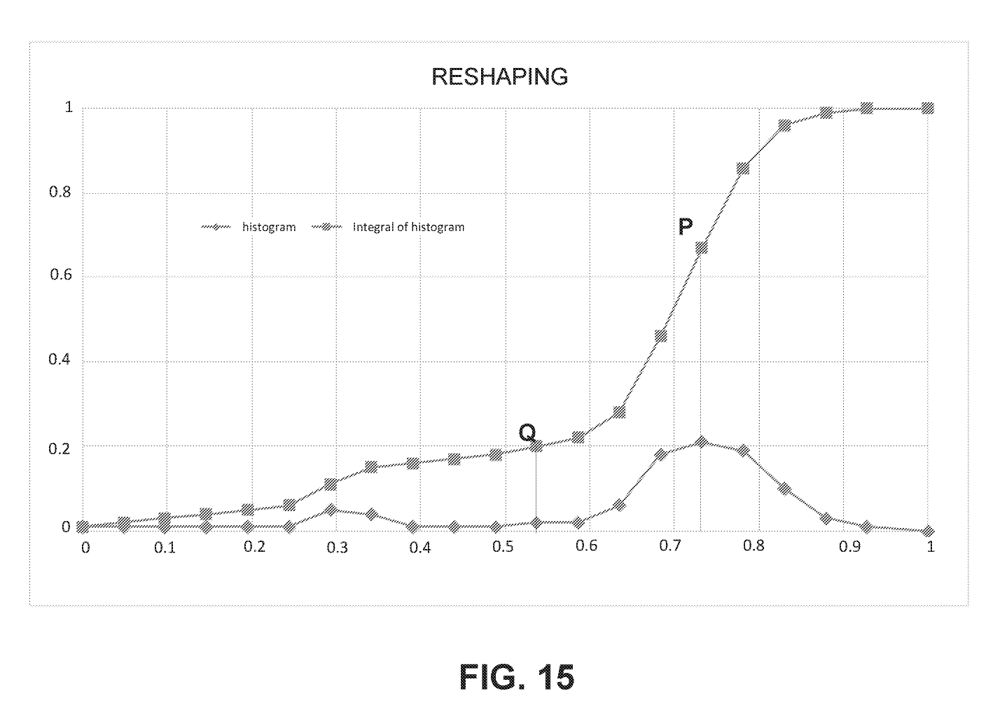

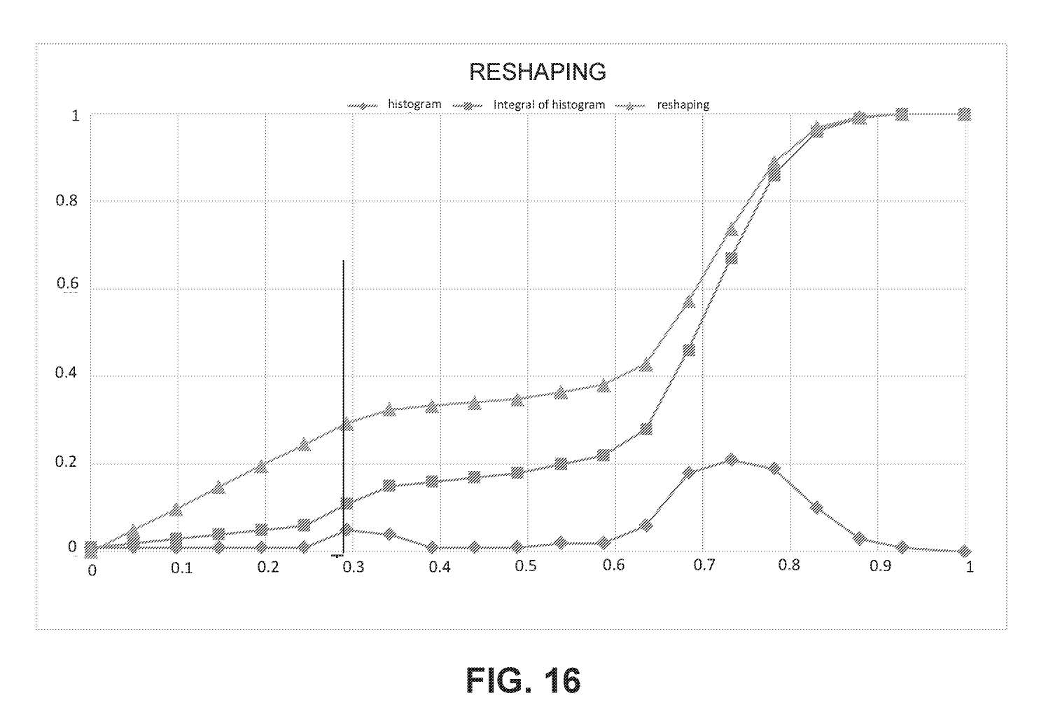

The PQ may be used as an Opto-Electro Transfer Function (OETF) that may convert linear light to the code level for general high dynamic range content in HDR workflow. For example, the 100 nits light may be converted to code level 510 by PQ, as shown in FIG. 7, and the 10000 nits light may be converted to maximum code level 1023. The PQ may allocate a number (e.g., half) of code levels to the light range that may cover the SDR part, while another number (e.g., half) of code levels may be allocated to another range (e.g., the range from 100 to 10000 nits). Content to be coded may be distributed (e.g., unevenly distributed, such as bright scene). A histogram of the scene (line with diamonds) is shown in FIG. 15. The horizontal axis may be the normalized code level from PQ quantization. The vertical axis may be a percentage. For example, more than 80% of pixels may be in the range [510-1023], which may occupy half of the code levels. Reallocating the code level for the whole code level range (e.g., based on the content) may be an important technology for HDR coding. This process may be referred to as reshaping. A potential reshaping method may reallocate the code level. For example, the code level may be relocated based on the distribution of actual content. The code level may be relocated based on the histogram. More code levels may be reallocated to those pixels with high occurrence. As shown in FIG. 15, reshaping may be done with an integral of a histogram. Turning to Equation (1), s(x) may represent the integral of histogram h, x may represent the input code level, y may represent reshaped code level, and M may represent the maximum code level. h(x/M) may represent the percentage of those input pixels having code level value of x. The reshaping may be performed as:

$$s ( x ) = {\sum }_{i < x} h ( \frac{i}{M} ) , i ∈ [ 0 , M ] \\ y = s ( x ) \times M \qquad ( Eq . 1 )$$

A reshaping process may be applied before an encoding process. The inverse reshaping parameters may be used to describe the inverse reshaping function that may be coded in bitstream. The decoded picture may be converted (e.g., converted back) by applying inverse reshaping after decoding.

HDR video coding may use the same bit-depth or higher bit-depth compared to SDR video coding. The dynamic range of the color components for HDR video may be much larger than that for SDR video. This may make compression more challenging. Methods for HDR evaluation may be different from SDR evaluation. For example, for SDR video coding, the objective quality metric (for example, PSNR) may be calculated between the input to encoder and the output from decoder (e.g., in YCbCr 4:2:0 format).

For HDR video, an objective quality metric calculation may be performed at an end to end point. For example, an objective quality metric calculation may be performed at an end to end point E and E′ (FIG. 8), which may be in linear RGB 4:4:4 format. Various coding artifacts may be visible in HDR display in medium and/or low bit-rate range. Such coding artifacts may include color bleeding, local hue change, banding, blocking, blurring, and/or ringing.

In traditional SDR coding, the bits used for chroma coding may be about 10% of the overall bitstream. Bits used for chroma coding in SDR may be lower than (e.g., considerably lower than) the number of bits for luma coding. Chroma artifacts may be less pronounced in SDR coding. Chroma coding may not be carefully handled in the SDR encoding process.

In HDR coding, the dynamic range of chroma may be increased and/or the number of bits used for chroma components may be increased. In bright scenes, chroma related artifacts (such as, for example, color bleeding and local hue changes) may be observed easily. HDR video sequences may have some different characteristics compared to SDR video. For example, there may be more details in dark area, more colorful scenes, frequent local/global illumination changes (for some or all color components), and/or more smooth transition areas in terms of luminance and/or color. Improvement methods may be implemented to help HDR video coding in terms of subjective and/or objective quality. Improvements may be implemented regarding one or more of: chroma coding; weighted prediction for luma and chroma changes; deblocking; and/or quantization parameter adjustment for coding unit.

A deblocking filter may be used to reduce blocking artifacts adaptively at transform unit and/or prediction unit boundaries. There may be one or more sets of filters for edge filtering (e.g., strong filters and weak filters). For example, there may be one or more sets of filters for edge filtering, depending on the boundary strength. The boundary strength may be determined by one or more factors using the coding parameters of two or more neighboring blocks, such as block coding type, the difference of quantization parameter (QP), the difference of motion vectors, and/or the presence of non-zero coefficients.

There may be one or more parameters (e.g., parameters β and t_{C}) that may control the deblocking filter. Parameter β may indicate the threshold to control whether the deblocking filter is applied. If the pixel difference across the boundary is greater than parameter β, then the boundary may be regarded as an edge (e.g., an existing edge) in the original signal that may need to be preserved (therefore deblocking filter may be turned off). Otherwise, the deblocking filter may be applied. Parameter t_{C} may be used to control the amplitude of the filtering, e.g., if deblocking filter is applied. In Equations (2)-(6), parameters “P” and “Q” may denote two or more (e.g., two) neighboring blocks at the horizontal and/or vertical boundary. Parameters β and t_{C} for luma deblocking may be derived as follows:

qP_{L}=((Qp_{Q}+Qp_{P}+1)>>1) (Eq. 2)

Q_{β}=Clip3(0,51,qP_{L}+(slice_beta_offset_div 2<<1)) (Eq. 3)

Q_{tc}=Clip3(0,53,qP_{L}+2*(bS−1)+(slice_tc_offset_div 2<<1)) (Eq. 4)

β=β′*(1<<(BitDepth_{Y}−8)) (Eq. 5)

t_{C}=t_{C}′*(1<<(BitDepth_{Y}−8)) (Eq. 6)

parameters Qp_{Q} and Qp_{P} may be the luma quantization parameters used for blocks P and Q, respectively. Parameter bS may be the boundary strength between blocks P and Q, and may range from 0 to 2 inclusive. Parameter BitDepth_{Y} may be the bit-depth of luma component. Parameters β′ and t_{C}′ are specified in Table 2 according to parameters Q_{β} and Q_{tc}, respectively. The “slice_beta_offset_div 2” and “slice_tc_offset_div 2” parameters may be parameters signaled at slice header (e.g., if the deblocking parameters are enabled to be signaled at slice level). The chroma deblocking may be performed in a similar way, and/or the QP in Equations (2)-(4) may be substituted by chroma quantization parameters.

TABLE 2 lists the derivation of threshold variables β′ and t_{C}′ from input Q.

TABLE 2

| | Q | | | | | | | | | | | | | | | | | | |
|---|---|---|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 | 16 | 17 | 18 |
| β′ | 0 | 0 | 0 | 0 | 0 | 0 | 0 | 0 | 0 | 0 | 0 | 0 | 0 | 0 | 0 | 0 | 6 | 7 | 8 |
| t_{C}′ | 0 | 0 | 0 | 0 | 0 | 0 | 0 | 0 | 0 | 0 | 0 | 0 | 0 | 0 | 0 | 0 | 0 | 0 | 1 |
| | Q | | | | | | | | | | | | | | | | | | |
| | 19 | 20 | 21 | 22 | 23 | 24 | 25 | 26 | 27 | 28 | 29 | 30 | 31 | 32 | 33 | 34 | 35 | 36 | 37 |
| β′ | 9 | 10 | 11 | 12 | 13 | 14 | 15 | 16 | 17 | 18 | 20 | 22 | 24 | 26 | 28 | 30 | 32 | 34 | 36 |
| t_{C}′ | 1 | 1 | 1 | 1 | 1 | 1 | 1 | 1 | 2 | 2 | 2 | 2 | 3 | 3 | 3 | 3 | 4 | 4 | 4 |

| | Q | | | | | | | | | | | | | | | |
|---|---|---|---|---|---|---|---|---|---|---|---|---|---|---|---|---|
| | 38 | 39 | 40 | 41 | 42 | 43 | 44 | 45 | 46 | 47 | 48 | 49 | 50 | 51 | 52 | 53 |
| β′ | 38 | 40 | 42 | 44 | 46 | 48 | 50 | 52 | 54 | 56 | 58 | 60 | 62 | 64 | — | — |
| t_{C}′ | 5 | 5 | 6 | 6 | 7 | 8 | 9 | 10 | 11 | 13 | 14 | 16 | 18 | 20 | 22 | 24 |

The deblocking parameters “slice_beta_offset_div 2” and “slice_tc_offset_div 2” may be used to adjust the deblocking filter for each slice (e.g., to get the best deblocking effects). In an encoder, these deblocking parameters may be set to 0 (e.g., may be set to 0 by default).

Implementations for encoding improvements for HDR video that may address (e.g., reduce) coding artifacts may be performed. Chroma quantization parameter adjustment may be performed at slice level for chroma quality improvement. Weighted prediction parameters estimation may be performed to improve inter prediction for video signal with luma and/or chroma illumination changes. Deblocking filter parameters may be performed. Quantization parameter adjustment for coding unit may be performed.

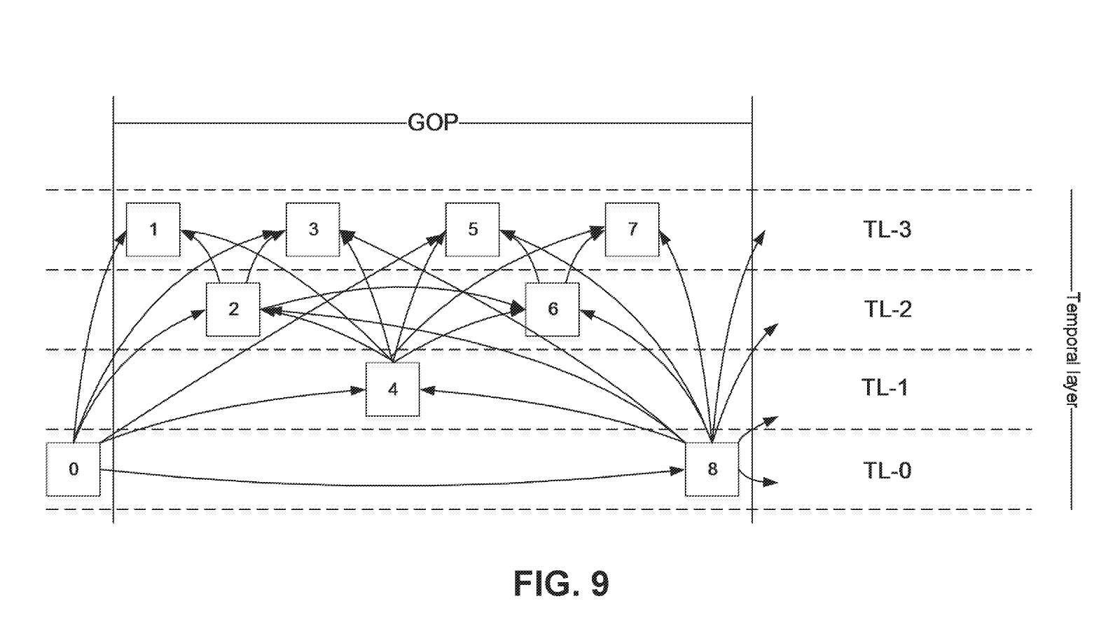

FIG. 9 shows an example hierarchical coding structure that may be used in video applications (e.g., streaming and/or broadcasting) to improve coding efficiency. For example, a video sequence may include pictures associated with different temporal levels. The video sequence may include one or more first-temporal level pictures associated with a first temporal level and one or more second-temporal level pictures associated with a second temporal level. First-temporal level pictures may comprise pictures at a lower temporal level (e.g., picture 0, picture 8) and second-temporal level pictures may comprise pictures at a higher layer (e.g., pictures 1, 3, 5, 7). The second-temporal level pictures may refer to the first-temporal level pictures, and the first-temporal level pictures may be reference pictures. There may be multiple temporal levels with different quality settings. For example, pictures at a lower temporal level (e.g., picture 0, picture 8) may have better quality using more coding bits compared to the pictures at a higher layer (e.g., pictures 1, 3, 5, 7). Implementations may consider characteristics associated with different temporal levels in hierarchical coding.

The sequence level chroma QP offsets for a chroma component (e.g., relative to the luma QP) may be signaled at a Picture Parameter Set (PPS), which may apply to the slices that refer to that PPS. The QP offsets signaled at PPS may affect the QP calculation used for chroma deblocking. The slice level chroma QP offsets may be signaled in the slice header, and/or may be applied (e.g., only applied) to that specific slice. The slice QP offsets may provide fine granularity adjustment. The slice QP offsets may not affect the QP calculation for chroma deblocking. The chroma QP adjustment may affect luma coding. For example, the chroma QP adjustment may affect luma coding because of the rate distortion optimization based mode decision used by the encoder. The RD cost for mode k (e.g., k being one or more of the eligible modes considered by the encoder) of a coding unit may be calculated as:

RDCostₖ=Dist_{L}(k)+(λ_{L}/λ_{C1})*Dist_{C1}(k)+(λ_{L}/λ_{C2})*Dist_{C2}(k)+λ_{L}(R_{L}(k)+R_{C1}(k)+R_{C2}(k)) (Eq. 7)

λ_{L}=lambda_weight_{L}*2^{(QPL/3)},λ_{C1}=lambda_weight_{C}*2^{(QPc1/3)},λ_{C2}=lambda_weight_{C}*2^{(QPc2/3)} (Eq. 8)

In Equation (7), Dist_{L}(k), Dist_{C1}(k) and Dist_{C2}(k) may be the distortion of luma and one or more (e.g., two) chroma components (e.g., denoted as C1, C2) for mode k, respectively. R_{L}(k), R_{C1}(k) and R_{C2}(k) may be the bits for coding the luma and two chroma components, respectively. λ_{L}, λ_{C1} and λ_{C2} may be the lambda factors for luma and two chroma components, which may depend on their QP values, respectively. λ may be calculated based on QP in Equation (8), where lambda_weight may be a weighting parameter that may depend on the temporal level of the current picture/slice. The distortion may be measured by sum of square error (SSE). The weight for chroma distortion (λ_{L}/λ_{C1} or λ_{L}/λ_{C2}) may be changed, e.g., when the chroma QP, QP_{C1} and/or QP_{C2}, is changed by the corresponding chroma QP offset signaled at picture and/or slice level.

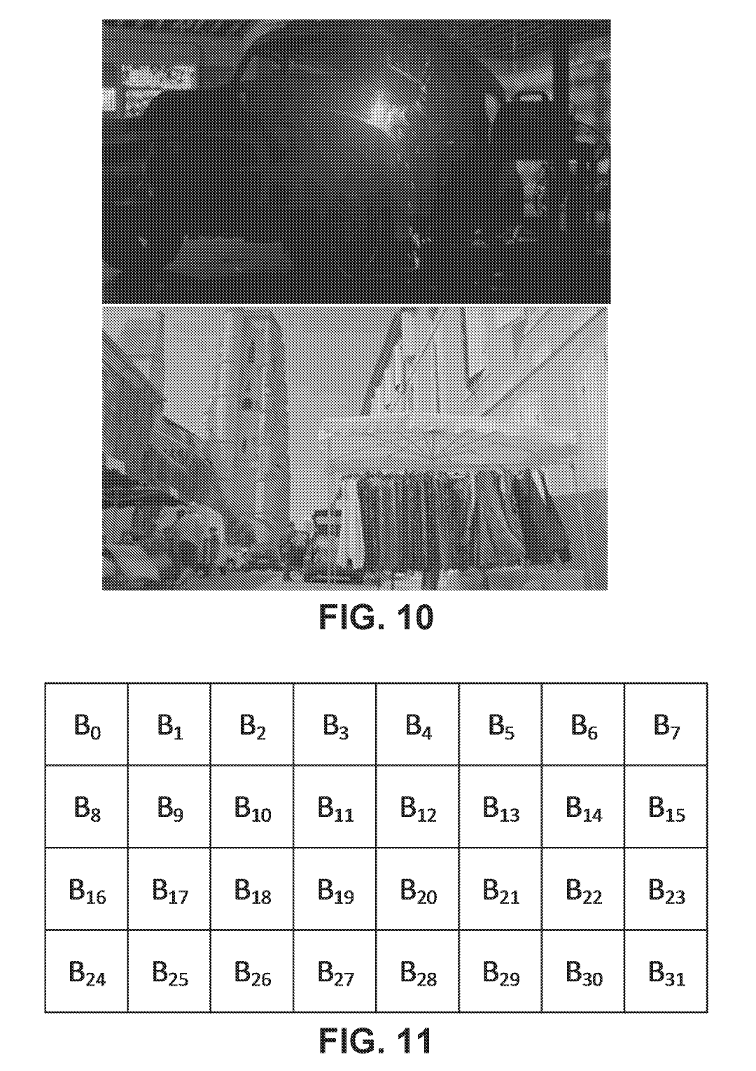

For example, if the QP of chroma component C1 is decreased, λ_{C1} may be decreased and/or the relative weight for that chroma C1 component may be increased. The RD cost function may bias to the mode that may provide smaller chroma distortion for C1. Similar behavior may exist for the other chroma component C2. Coding of the luma component may be affected. If the chroma QP is overly decreased, the overall coding performance may be degraded. For example, if the chroma QP is overly decreased, the overall coding performance may be degraded because of the potentially negative impact on luma coding. If the scene is dark (e.g., luminance is low), the scene may not be very colorful and/or chroma energy may be low (as shown in FIG. 10, top). Chroma QP may be adjusted based on the chroma energy in the picture.

Chroma QP adjustment may be based on hierarchical coding structure. For example, a video sequence may include a first-temporal level picture and a second-temporal level picture. The first-temporal level picture may be associated with a first temporal level, and/or the second-temporal level picture may be associated with a second temporal level. The second-temporal level picture may use the first-temporal level picture as the reference picture. Chroma QP values for a picture may be adjusted based on the temporal level of the picture. The chroma QP may be set to be small for those pictures in lower temporal level (e.g., so that the chroma quality of the lower temporal level pictures is kept relatively high). The chroma QP may be set to be large for those pictures in higher temporal levels.

Chroma QP adjustment may be based on chroma activity level. Chroma activity may be used to measure the chroma energy in the picture. The chroma component C (e.g., C may be C1 and/or C2) of the slice may be partitioned into blocks (e.g., equal sized blocks, such as 32×32). The chroma activity for block Bi of the component C, denoted as Act_{C}(Bᵢ), may be defined as:

Act_{C}(Bᵢ)=Σ_{(x,y)∈B}_{ᵢ}(|C(x,y)−DC(Bᵢ)|))/A(Bᵢ) (Eq. 9)

Parameters DC(Bᵢ) may be the DC value of block Bᵢ. A(Bᵢ) may indicate the number of pixels within block Bᵢ. The chroma activity of the chroma component C may be equal to the average of chroma activity of the blocks (e.g., a subset of, or all, blocks). N may indicate number of blocks in chroma component C.

Act_{C}=(Σ_{B}_{ᵢ}_{∈C}Act_{C}(Bᵢ))/N (Eq. 10)

If the chroma activity Act_{C} is smaller than a predefined threshold, then the chroma QP may not be adjusted. Otherwise, the chroma QP offset of chroma component C “QP_offset_{C}” for the slice may be adjusted as follows:

$${QP\_offset}_{C} = \{ \begin{matrix}- 1 , & if ( {Act}_{C} < TH 1 [ tlIdx ] ) \\ - 2 , & else if ( {Act}_{C} < TH 2 [ tlIdx ] ) \\ MinDQP [ tlIdx ] , & otherwise\end{matrix} \qquad ( Eq . 11 )$$

Parameters TH1[tlIdx] and TH2[tlIdx] may be predefined thresholds, with TH1 [tlIdx]<TH2[tlIdx]. tlIdx may indicate the temporal level that the picture may belong to, MinDQP[tlIdx] may indicate the predefined QP offset for temporal level tlIdx. MinDQP[tlIdx] may be less than −2. For example, MinDQP[tlIdx] may be −3, −4, etc. This method may be applied to CU based chroma QP adjustment (for example, if CU level chroma QP offset signaling is enabled).

The chroma coding bits may be allocated according to the temporal level. The pictures associated with a low temporal level may be used as references for the coding of those pictures at high temporal level. More chroma coding bits may be allocated to low temporal level pictures, and fewer chroma coding bits may be allocated to high temporal level pictures. For example, chroma QP offset may be determined based on the temporal level to which a slice or a CU belongs to. The chroma QP offset value of the picture in low temporal level may be smaller than the chroma QP offset value of the picture in higher temporal level. For example, chroma QP offset may be set equal to −1 for picture 0 and picture 8 as shown FIG. 9, 0 for picture 4, 1 for picture 2 and picture 6, 2 for picture 1, picture 3, picture 5 and picture 7.

Chroma QP may be adjusted based on the artistic characteristics. For example, the encoder may adjust the chroma QP offset adaptively at the slice level according to the percentage of samples in slice belonging to one or more color sets specified by artistic characteristics, such that the chroma fidelity may be better preserved. For example, the encoder may adjust the chroma QP offset adaptively at the CU level according to the percentage of samples in CU region belonging to one or more color sets specified by artistic characteristics.

The chroma components (e.g., C1 and C2) may refer to different color components depending on the coding color space. For example, the chroma components may be Cb/Cr or Cg/Co if the coding color space is YCbCr or YCgCo. If the coding color space is RGB, then two chroma components may be B and R.

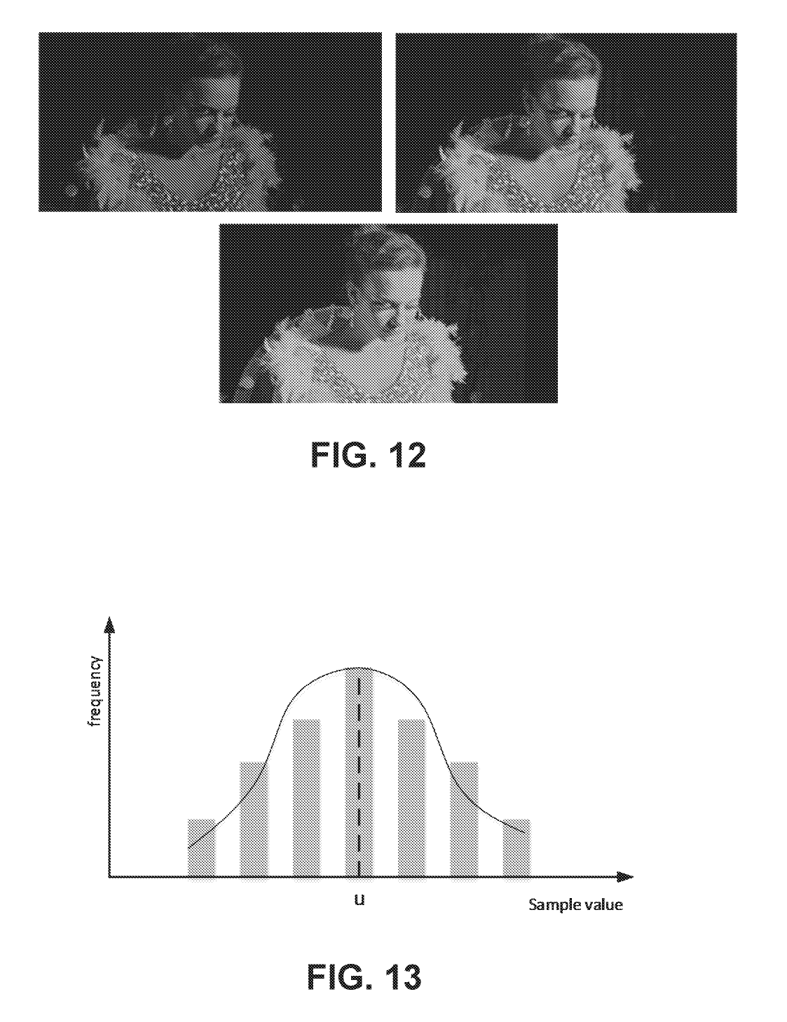

Weighted prediction parameter estimation may be provided. The global and/or local illumination change in one or more of the color components may occur in HDR video. The precision of HDR video may be higher than SDR, and HDR video may capture a small global/local illumination change. FIG. 12 is an example of global illumination for an HDR test sequence. Weighted prediction (WP) may be an effective coding tool to improve the inter prediction accuracy, e.g., when the component sample values for the current picture and/or the current picture's reference picture may be different. Weighted prediction may be generated by Equation (12), where Pred may be the weighted prediction, MCP(refPic) may be the conventional motion compensated prediction using reference picture refPic without weighted prediction, and w(rePic) and o(refPic) may be the weight and/or offset between current picture and reference picture, respectively. Equation (12) assumes uni-prediction may be used (e.g., for bi-prediction, one or more (e.g., two) pairs of weight and/or offset (e.g., one for each reference picture), may be used):

Pred=w(refPic)*MCP(refPic)+o(refPic) (Eq. 12)

The WP parameters (e.g., weight and/or offset) may be important to the accuracy of weighted prediction. WP parameters may be estimated based on the AC and DC value of two pictures, e.g., in HEVC reference software. DC may be the mean value of one component of the picture (e.g., the whole picture). The AC of component k may be calculated with Equation (13), where k may be one or more (e.g., any) of the luma and/or chroma color components.

ACₖ=Σ_{(x,y)∈C}(|C(x,y)−DCₖ|) (Eq. 13)

The WP parameters of component k between current picture “currPic” and reference picture “refPic” may be estimated as follows:

Wₖ(refPic)=ACₖ(currPic)/ACₖ(refPic) (Eq. 14)

Oₖ(refPic)=DCₖ(currPic)−wₖ(refPic)*DCₖ(refPic) (Eq. 15)

Weighted parameter estimation methods may derive accurate weight and/or offset values. WP parameter estimation of a given color component may be performed in the following way, and/or the estimation of other components may be performed (e.g., performed in the same way). The component notation “k” may be omitted in the equations.

If the sample value of the given color component of the reference picture satisfies Gaussian distribution, then the histogram Fr may be depicted by Equation (16), where μᵣ and σᵣ may be the mean and variance of the Gaussian distribution of the color component of the reference picture, and Mᵣ may be the normalization factor to ensure that probabilities sum to 1.

Fᵣ(ν)=Mᵣ*e^{-(ν-μ}^{ᵣ}⁾^{²}^{/(3*σ}^{ᵣ}^{²}⁾ (Eq. 16)

There may be a linear mapping relationship between current picture and reference picture (e.g., V_{C}=w*Vᵣ+o, where Vc and Vr may be the sample values of the current picture and reference picture, respectively). The histogram of current picture F_{c} may be represented as:

F_{c}(ν)=M_{c}*e^{-(ν-μ}^{_{c}}⁾^{²}^{/(2*σ}^{_{c}}^{²}⁾ (Eq. 17)

where μ_{c} and σ_{c} may be the mean and variance of the Gaussian distribution of the color component of the current picture. (μ_{c}, σ_{c}) may have the following relationship with (μᵣ, σᵣ):

σ_{c}=w*σᵣ (Eq. 18)

μ_{c}=w*μᵣ+o (Eq. 19)

(w, o) may be calculated as:

w=σ_{c}/σᵣ (Eq. 20)

o=μ_{c}−w*μᵣ (Eq. 21)

Using the Least Square method to estimate the mean and variance by fitting histogram with Equation (16) may be shown in FIG. 13.

Equation (16) may be transformed by logarithmic function:

$$ln ( {F}_{r} ( v ) ) = - \frac{{v}^{2}}{2 {σ}_{r}^{2}} + \frac{{μ}_{r}}{{σ}_{r}^{2}} v + ( ln {M}_{r} - \frac{{μ}_{r}^{2}}{2 {σ}_{r}^{2}} ) , v ∈ [ 0 , V ] \qquad ( Eq . 22 )$$

The Equation (22) may be changed to a linear form as:

$$ln ( {F}_{r} ( v ) ) = - \frac{{v}^{2}}{2} * A + v * B + T , v ∈ [ 0 , V ] \qquad ( Eq . 23 )$$

where variable A, B and T may be set as

$$A = \frac{1}{{σ}_{r}^{2}} , B = \frac{{μ}_{r}}{{σ}_{r}^{2}} , T = ( ln {M}_{r} - \frac{{μ}_{r}^{2}}{2 {σ}_{r}^{2}} ) ,$$

A, B and T may be solved by Least Square method as follows:

$$( A , B , T ) = {arg}_{( A , B , T )} min {\sum }_{v} {( ln ( {F}_{r} ( v ) ) - ( - \frac{{v}^{2}}{2} * A + v * B + T ) )}^{2} \qquad ( Eq . 24 )$$

The (μᵣ, σᵣ) may be calculated as:

$${μ}_{r} = \frac{B}{A} , {σ}_{r} = \frac{1}{{A}^{1 / 2}} .$$

In the same way, (μ_{c}, σ_{c}) may be calculated. The WP parameters (w, o) may be calculated with Equations (20) and (21). If LS fails when solving Equation (24), then WP parameters may be estimated with the AC/DC method in Equations (14) and (15).

Current picture and reference picture may be aligned via motion estimation. The weight and offset may be estimated using the Least Square (LS) method. Given motion compensated prediction MCP without weighted prediction, the WP parameter (w, o) may be estimated by solving Equation (25) with LS method where C(x,y) may be the color component value at (x,y) of the current picture, refPic may be the reference picture, (mvx, mvy) may be the motion vectors for the block located at (x,y) using refPic, and MCP may be the motion compensation function.

(w,o)oₚₜ=arg_{(w,o)}min Σ_{(x,y)∈C}(C(x,y)−w*MCP(refPic,mvx,mvy)−o)²) (Eq. 25)

Deblocking filter parameters may be selected by an encoder and signaled in the bitstream. Deblocking filter parameters may be signaled in a slice header. For example, deblocking filter parameters “slice_beta_offset_div 2” (e.g., beta offset) and/or “slice_tc_offset_div 2” (e.g., t_{C} offset) may be signaled in a slice header. The deblocking filter parameters “slice_beta_offset_div 2” and “slice_tc_offset_div 2” may be used to adjust the deblocking filter for each slice (e.g., to get the best deblocking effects).

Deblocking filter parameters may be selected (e.g., adaptively selected) based on the reconstructed picture quality. A fast deblocking parameters searching algorithm and/or a refinement method for quality smoothing may be performed. For example, deblocking parameters may be searched within predefined search windows, and deblocking parameters may be selected by calculating and/or comparing distortion of possible deblocking parameters.

Deblocking filter parameters β and/or t_{C} may be increased. For example, β and/or t_{C} may be increased to make the deblocking filter stronger, such that more blocking artifacts may be removed. Parameters β and/or t_{C} may be increased if the reconstructed picture is not of a sufficient quality (e.g., because the QP values applied to code the picture are large).

Parameters β and/or t_{C} may control the deblocking filter. For example, parameter β may indicate the threshold to control whether the deblocking filter is performed. If the pixel difference across the boundary is greater than parameter β, then the boundary may be regarded as an edge in a signal (e.g., the original signal) that may need to be preserved, and the deblocking filter may be turned off. If the pixel difference across the boundary is not greater than parameter β, the deblocking filter may be applied. Parameter t_{C} may be used to control the amplitude of the filtering, e.g., may be used to control the amplitude of the filtering if deblocking filter is applied.

The β and/or t_{C} values may be decreased (e.g., to make the deblocking filter weaker). For example, the β and/or t_{C} values may be decreased if the reconstructed picture quality is sufficient. The encoder may select β and/or t_{C} to minimize the distortion between deblocked picture and/or the original picture. Parameters β offset and t_{C} offset may be denoted as BO and TO, respectively:

(BO,TO)oₚₜ=arg_{(BO,TO)}min Distortion(DB(rec,BO,TO),org_{YCbCr}) (Eq. 26)

where rec may be the reconstructed picture before deblocking; org_{YCbCr} may be the original picture in coding color space (e.g., such as YCbCr 4:2:0); DB(rec, BO, TO) may be the deblocked picture generated by deblocking reconstructed picture rec with BO and TO parameters. The distortion between the two pictures may be the weighted sum of individual distortion of one or more components (e.g., each component), including luma and/or two chroma components. The encoder may compare the distortion of possible BO, TO pairs and/or identify an optimal pair. For example, the encoder may, in a brute force manner, compare the distortion of possible BO, TO pairs and/or identify an optimal pair.

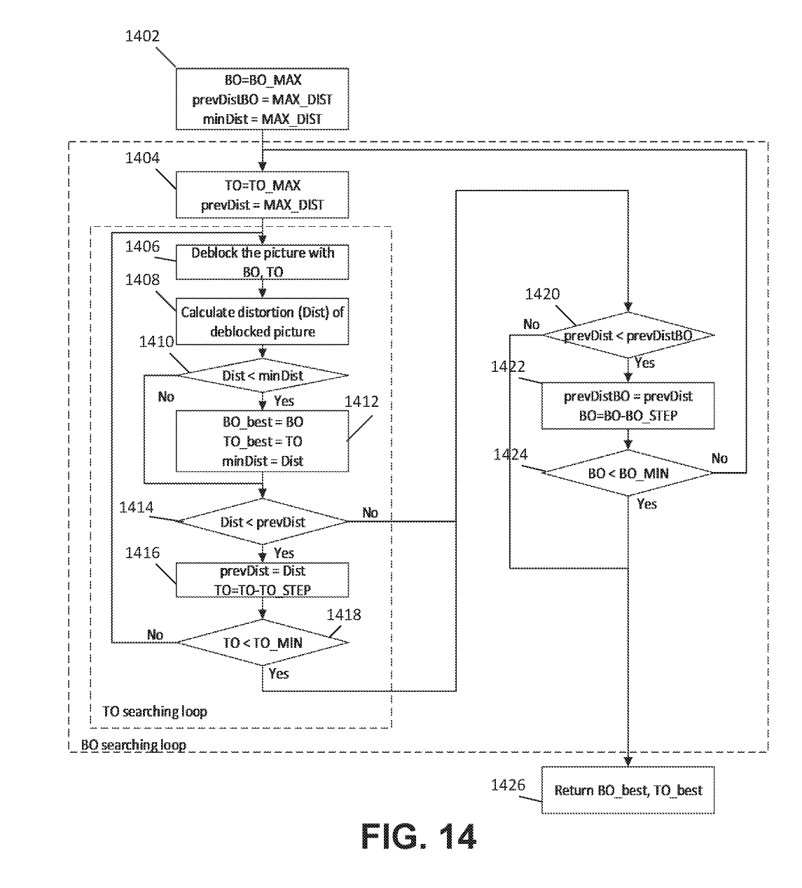

An early termination technique may be performed. For example, an early termination technique may be performed to accelerate the parameter searching process. FIG. 14 shows an example fast search technique with early termination. As shown in FIG. 14, one or more (e.g., two) loops may be performed: one or more loops may be performed for TO searching, and one or more loops may be performed for BO searching. The one or more loops performed for TO searching may be the same, or different, than the one or more loops performed for BO searching. One or more of the loops may be terminated early. For example, if the distortion increases in a loop, one or more of the loops may be terminated early.

As shown in FIG. 14, a value for the BO (e.g., β, also referred to as beta) parameter may be identified. The BO parameter may indicate a value (e.g., a threshold) to control whether the deblocking filter may be performed. The BO parameter may be set to a predetermined BO value. The BO parameter may be set to a value within a BO search window. For example, at 1402, BO may be set to the maximum BO value in the BO search window (e.g. BO_MAX). Parameter BO_MAX may indicate the maximum value of the BO parameter that may be permitted within a predetermined parameter search window. A previous distortion of BO (e.g., prevDistBO) parameter may be set. The previous distortion of BO parameter may indicate a previously distortion value calculated based on a previous BO value. The previous distortion of BO (e.g., prevDistBO) parameter may be initially set to a maximum distortion value (e.g., MAX_DIST). The maximum value of the distortion parameter for distortion initialization may indicate the maximum value of the distortion that may be permitted, denoted as MAX_DIST. A minimum distortion parameter (e.g., minDist) may be initialized. The minimum distortion parameter may indicate the lowest value of distortion that may be achieved in the parameter searching process. The minimum distortion parameter (e.g., minDist) may be initially set to the maximum distortion (e.g., MAX_DIST) parameter, at 1402.

A value for the TO parameter (e.g., t_{C}) may be identified. The TO parameter may be used to control the amplitude of the filtering. For example, the TO parameter may be used to control the amplitude of the filtering, if a deblocking filter is applied. The TO parameter may be set to a predetermined value. For example, the TO parameter may be set to the maximum value of TO in a TO search window (TO_MAX), at 1404. The maximum value of TO may indicate the maximum value of TO that may be permitted within a predefined parameter search window. The previous distortion (e.g., prevDist) parameter may be initially set to a predefined value. For example, the previous distortion parameter may be set to the maximum distortion, at 1404. The previous distortion (e.g., prevDist) parameter may be used to indicate the previously calculated distortion value, for example, using a previous TO value (and/or a previous BO value).

As shown in FIG. 14, a first loop (e.g., TO searching loop) may be entered. A picture may be deblocked, at 1406. For example, a picture may be deblocked using the BO parameter and the TO parameter. A distortion (e.g., Dist) value may be calculated. For example, a distortion value of the deblocked picture may be calculated, at 1408. The distortion value may be associated with using the BO parameter and the TO parameter. For example, the distortion value may be associated with using the BO parameter and the TO parameter for performing deblocking filtering. The distortion value may be compared with the recorded minimum distortion previously achieved. For example, the distortion may be compared with the minimum distortion (e.g., minDist) value, at 1410. If the distortion value is not less than the minimum distortion value, the distortion value may be compared with a previous distortion value, at 1414. If the distortion (e.g., Dist) value is less than the minimum distortion (e.g., minDist) value, parameters BO_best and TO_best may be set, and minDist may be updated. For example, if the distortion value is less than the minimum distortion value, the parameter BO_best may be set to BO and the parameter TO_best may be set to TO, and minDist may be set to Dist at 1412. The BO_best parameter and/or the TO_best parameter may be determined to comprise the best available values of BO and TO, respectively. The BO_best parameter and/or the TO_best parameter may be signaled as the deblocking parameters.

The distortion value may be compared with a previous distortion (e.g., prevDist) value, at 1414. If the distortion value is not less than the previous distortion (e.g., prevDist) value, then the previous distortion value may be compared with a predefined value (e.g., the predefined value may be a constant value and/or a nonconstant value). For example, if the distortion value is not less than the previous distortion (e.g., prevDist) value, then the previous distortion value may be compared with a previous distortion of BO (e.g., prevDistBO) parameter, at 1420. The previous distortion of BO (e.g., prevDistBO) parameter may be originally set at 1402 and/or the previous distortion of BO parameter may be updated at 1422. The previous distortion of BO (e.g., prevDistBO) parameter may be referred to as the second previous distortion parameter. The previous distortion of BO (e.g., prevDistBO) parameter may be referred to as the next prevDistBO parameter and/or the BO parameter may be referred to as the next BO parameter, e.g., upon successive passes through the loop. The next prevDistBO may be referred to as the next second previous distortion parameter.

If, at 1414, the distortion value is less than the previous distortion (e.g., prevDist) value, the value of the previous distortion (e.g., prevDist) parameter and/or the value of the TO parameter may be set to predetermined values. For example, if the distortion value is determined to be less than the previous distortion value, the value of the previous distortion parameter may be set to the distortion (e.g., Dist) value, at 1416. If the distortion value is determined to be less than the previous distortion value, at 1414, the TO parameter may be decremented by the value of the TO_STEP parameter. Parameter TO_STEP may indicate the step size used for TO parameter consecutive search.

It may be determined whether TO is within the TO search window. For example, it may be determined, at 1418, whether TO is less than TO_MIN, a parameter that may indicate the minimum TO value in the TO parameter search window. If the value of the TO parameter is less than the value of the TO_MIN parameter, the previous distortion parameter may be compared with a predetermined value. For example, if the value of the TO parameter is less than the value of the TO_MIN parameter, it may be determined whether the previous distortion (e.g., prevDist) is less than the previous distortion of BO (e.g., prevDistBO), at 1420. If the TO parameter is not less than the TO_MIN parameter, the picture may be deblocked. For example, if the TO parameter is not less than the TO_MIN parameter, the picture may be deblocked with the BO parameter and/or the TO parameter, at 1406. For example, if the TO parameter is not less than TO_MIN parameter, return to the beginning of the TO searching loop. Upon returning to the beginning of the TO searching loop, a next set of parameters (e.g., next distortion, next BO_best, next TO_best, next minDist, next previous distortion, next TO, etc.) may be calculated and/or set.

Whether the present TO and BO parameters may be signaled as deblocking parameters may be determined, for example, by comparing the previous distortion value with another previous distortion value. For example, at 1420, it may be determined whether the previous distortion (e.g., prevDist) parameter is less than the previous distortion of BO (e.g., prevDistBO) parameter. If the previous distortion (e.g., prevDist) parameter is not less than the previous distortion of BO (e.g., prevDistBO) parameter, at 1426, the BO_best parameter and/or the TO_best parameter may be returned. The BO_best parameter and/or the TO_best parameter may be determined to indicate best available values of BO and TO, respectively. The returned BO_best parameter and TO best parameter may be signaled as the deblocking parameters for the picture.

If, at 1420, the previous distortion (e.g., prevDist) parameter is less than the previous distortion of BO parameter, the previous distortion of BO (e.g., prevDistBO) parameter and/or the BO parameter may be set to predetermined values. For example, if the previous distortion parameter is less than the previous distortion of BO parameter, the previous distortion of BO (e.g., prevDistBO) parameter may be set equal to the previous distortion (e.g., prevDist) parameter, at 1422. The BO parameter may be decremented by a predetermined value, such as BO_STEP that may indicate the step size used for BO parameter consecutive searching. It may be determined whether the BO parameter is less than a predefined parameter. For example, it may be determined whether the BO parameter is less than the minimum of the BO parameter (e.g., BO_MIN), at 1424. The BO_MIN parameter may indicate the minimum value of the BO parameter that may be permitted in BO parameter search window. If the BO parameter is not less than the value of BO_MIN, return to the TO searching loop, at 1404. The TO parameter and/or the previous distortion value may be set. For example, if the BO parameter is not less than the value of BO_MIN, the TO parameter and/or the previous distortion value may be set to a next set of values (e.g., next TO, next previous distortion, etc.). The value of the TO parameter (e.g., the next TO) may be set to the maximum value of the TO parameter (e.g., TO_MAX), and/or the previous distortion (e.g., the next prevDist) parameter may be set to the value of the maximum distortion (e.g., MAX_DIST) parameter, at 1404. If the BO parameter is less than the value of the BO_MIN parameter, the BO_best parameter and/or the TO_best parameter may be returned, at 1426.

The encoder may reduce (e.g., minimize) the distortion of deblocked pictures. The deblocking parameters may vary for one or more pictures (e.g., those pictures at the same temporal level). Flickering may be addressed. Quality variation of the pictures that may be used as a reference picture for coding of future pictures may be addressed. Considering the hierarchical coding structure (as shown in FIG. 9), pictures at the same temporal level coded with the same QP may have similar quality. Pictures at the same temporal level may have similar deblocking parameters. To ensure quality consistency among pictures at the same temporal level, deblocking parameters of the last picture at a temporal level in coding order during encoding may be recorded. The deblocking parameters for the current picture may be refined within a relative small window in parameter space. The full search window may be used, e.g., if the picture is the first coding picture at that temporal level. The full search window may be defined as [TO MIN, TO_MAX]×[BO_MIN, BO_MAX] (e.g., FIG. 14). The last stored deblocking parameters for temporal level tlIdx may be denoted as (TO[tlIdx], BO[tlIdx]). The search window for refinement may be defined as [TO_MIN_R, TO_MAX_R]×[BO_MIN_R, BO_MAX_R], where those variables may be derived as:

TO_MIN_R=max(TO_MIN,TO[tlIdx]−TO_R)

TO_MAX_R=min(TO_MAX,TO[tlIdx]+TO_R)

BO_MIN_R=max(BO_MIN,BO[tlIdx]−BO_R)

BO_MAX_R=min(BO_MAX,BO[tlIdx]+BO_R)

where TO_R and BO_R may represent a smaller range of refinement window for TO and BO, respectively. For example, TO_R and BO_R may be half of the full range of TO and BO, respectively.

Deblocking parameters (e.g., the same deblocking parameters) may be used for pictures at the same temporal level (e.g, to keep quality variations as small as possible). Deblocking parameters (e.g., the same deblocking parameters) may allow deblocking parameters to change among temporal levels (e.g., different temporal levels). The period of pictures at the same temporal level (e.g., sharing the same deblocking parameters) may be one or more group of pictures (GOP), one or more video shots, and/or the whole sequence.

The distortion calculation in Equation (26) may be carried in other color spaces (e.g., in addition to, and/or instead of, the coding color space) to further improve HDR coding from an end to end point of view. For example, the deblocked picture may be upsampled to YCbCr 4:4:4, and/or the distortion may be calculated against the original picture in YCbCr 4:4:4.

The deblocked picture may be upsampled and/or converted to RGB 4:4:4, and/or the distortion calculated in the RGB color space.

Quantization parameter adjustment may be provided. The QP offset may be adjusted (e.g., explicitly adjusted) at the coding unit level in HEVC, and/or the video quality in a local area may be adjusted (e.g., adjusted accordingly). The subjective quality may be improved if the quality of regions (e.g., regions sensitive to human vision) is improved. In HDR video coding, the artifacts appearing in bright regions (e.g., with less textures and small motion) may be more visible.

The following characteristics of a CU may be checked to determine whether to improve quality:

DC(mean) of luminance of CU: DC_{CU}=(Σ_{(x,y)∈CU}L(x,y))/Area(CU)

Spatial activity of CU: SA_{CU}=(Σ_{(x,y)∈CU}(|L(x,y)−L(x−1,y)|+|L(x,y)−L(x,y−1)|))/Area(CU)

The temporal activity: TA_{CU}=(Σ_{(x,y)∈CU}|L(x,y)−L′(x,y)|)/Area(CU)

where L(x,y) may be the luma sample value at position (x,y) in the current picture, L′(x,y) may be the luma sample value at position (x,y) in the previous picture in display order. If the following three conditions are satisfied (e.g., the current CU represents a bright area with relatively low spatial complexity and/or low temporal motion):

DC_{CU}>LUMA_TH;

SA_{CU}<SA_TH;

TA_{CU}<TA_TH;

then the encoder may reduce the QP for that CU (e.g., may reduce the QP value for that CU accordingly). The encoder may reduce the QP for a CU on a condition that one or more of the conditions may be satisfied.

For objective quality improvement, the encoder may find the optimal QP within a QP range for a CU to reduce (e.g. minimize) the RD cost. The optimal QP may be defined as Equation (27).

QP_{Opt}=arg_{QP∈QP}_{_{Range}}min(RDCost(QP)) (Eq. 27)

In block based video coding, large sized CUs may be chosen for homogeneous regions and/or small sized CUs may be chosen for regions with more texture. The encoder may be restricted to check CU level QP adjustment for small sized CUs (e.g., CUs smaller than 16×16 or smaller than 32×32).

QP may be adjusted based upon content. Code levels may be reallocated by the reshaping process before the encoding, and modified code levels may be converted back by an inverse reshaping process after decoding. A quantization parameter adjustment in the encoding process (e.g., without applying reshaping in pre-processing) may achieve functionality similar to that of applying reshaping in the pre-processing. Turning to Equation (28), x may represent an input of reshaping, and/or y may represent an output of reshaping, where r(x) may be the reshaping function. The reshaping process may be depicted as:

y=r(x) (Eq. 28)

The derivative of Equation (28) is:

dy/dx=r′(x) (Eq. 29)

Equation (29) may indicate that the residual of reshaped signal may be scaled compared to the residual without reshaping. This scaling effect may be achieved by adjusting QP (e.g., adjusting QP accordingly). Turning to Equation (30), QSₓ may represent the quantization step (QS) used for the quantization of signal x without reshaping, and QS_{y} may represent the QS used for the quantization of reshaped signal y. Equation (30) may indicate a relationship for reshaping and/or un-reshaping signal if one or more (e.g., both) of the signal get the equal quantized result:

dx/QSₓ=dy/QS_{y} (Eq. 30)

The change of QS may be calculated as:

log(QSₓ)−log(QS_{y})=log(dx/dy) (Eq. 31)

Turning to Equation (32), the change of QS may be calculated with a reshaping function by substituting Equation (29) in Equation (31):

log(QSₓ)−log(QS_{y})=−log(r′(x)) (Eq. 32)

Turning to Equation (33), the relationship between QS and QP may be:

QS=2^{(QP-4)/6} (Eq. 33)

Turning to Equation (34), the change of QP may be calculated by substituting Equation (33) into Equation (32):

ΔQP=QPₓ−QP_{y}=−6×log(r′(x)) (Eq. 34)

The QP change may be signaled at CU level. Using the average of luminance within the CU/CTU as input for Equation (32), the QP adjustment (e.g., for that CU/CTU) may be calculated. Turning to Equation (35), the delta QP may be clipped within a certain range to avoid a large variation:

ΔQP=Clip3(MIN,MAX,−6×log(r′(x)) (Eq. 35)

where MIN and MAX may be the lower and upper bound of QP changes allowed in the encoding, respectively.

There may be different ways to derive a reshaping function (e.g., derive a reshaping function automatically). For example, the integral of histogram of the scene may be used as the reshaping function, as shown in FIG. 15. In the figure, the line with diamonds may represent the histogram and the line with squares may represent the integral of the histogram. In the reshaping, for those in a sample value range having higher occurrence rate, the precision of code level may increase, otherwise, the precision of code level may decrease. For example, in FIG. 15, the precision at the position P may increase and/or the precision at the position of Q may decrease. From Equation (34), it may be determined that if r′(x) is greater than 1, the encoder may decrease QP for the signal x without reshaping. For position P, the QP may decrease because r′(P) may be greater than 1. For position Q, the QP may increase because r′(Q) may be smaller than 1. In this way, the encoder may achieve the similar effect as reshaping in pre-processing.

The reshaping function for the scene may be derived based on the histogram. This method may consider subjective quality. For example, this method may consider subjective quality in order to keep the user experience within normal light strength range such as SDR (where the light is less than 100 nits). A code level above the threshold (e.g., only the code level above the threshold) may be adjusted (e.g., based on the histogram). A code level below the threshold may be kept unchanged. Turning to Equation (36), the threshold T may be set as:

T=Min(OETF(100),argₓMin(s(x)>PT)) (Eq. 36)

where s(x) may be the integral of histogram, PT may be percentage threshold to indicate how many pixels are kept unchanged. If PQ (ST.2084) is used as OETF, then OETF(100) may be equal to 510 (as shown in FIG. 7). PT may be set as 10%. T may be equal to 300 (e.g., calculated as (0.293*1023)), as may be calculated by Equation (36). For the normalized range [0, 0.293], the linear mapping may be used for reshaping (e.g., to keep the precision). For the remaining range, the scaled integral of histogram with the offset 0.293 may be used for reshaping. Note that in the figure, the lowest curve (e.g., diamonds) may represent the histogram, the center curve (e.g., squares) may represent the integral of the histogram, and the top curve (e.g., triangles) may illustrate the resulting reshaping curve. The resulting reshaping curve may have a linear portion to the left of x=0.293, and the reshaping curve may be a scaled representation of the integral of histogram to the right of x=0.293.

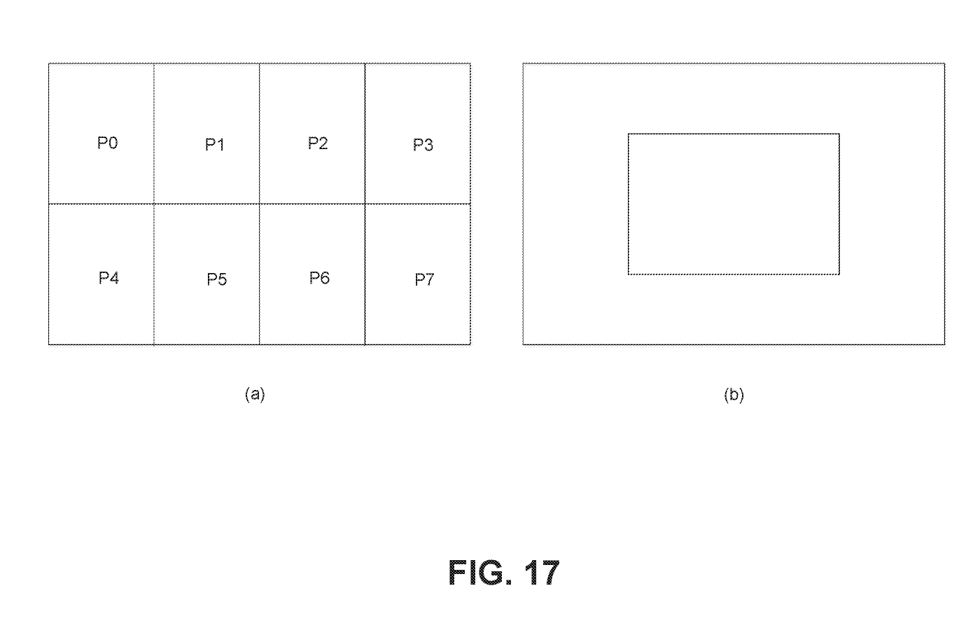

QP may be adjusted based upon region. For example, the QP adjustment based on the reshaping curves may be extended for a multiple regions case. As shown in FIG. 17, a picture may be partitioned. For example, a picture may be partitioned in different ways. The reshaping function may be different. For example, the reshaping function may be different for a region. The reshaping function may be generated based on the histogram of that region. For example, a region-specific histogram may be generated from the pixels in a region, and/or the integral-of-histogram for the region may be computed from the region-specific histogram. The reshaping function may be generated manually based on subjective quality. The QP of those coding blocks belonging to one region may be adjusted based on that region's reshaping function (e.g., instead of the global reshaping function). A QP adjustment for contrast preservation based on a region-specific reshaping function may be more accurate than a QP adjustment based on a global reshaping function. For example, if a reshaping curve is generated based on a full picture histogram, there may be insufficient information (e.g., in the global histogram, and/or in the global reshaping curve generated from the global histogram) about which pixels may be close to which other pixels. Each pixel may contribute to a histogram bin. An approach may be to partition the image into one or more (e.g., multiple) regions, and may be to generate a reshaping curve for a region, and/or may parameterize and/or send those curves (and/or may apply reshaping and inverse reshaping as pre-and-post processing).

A region based QP adjustment may include the following. The current picture may be partitioned into multiple regions (e.g., multiple local regions). The partition may be arbitrary. A local region may include multiple CU's. Reshaping curves for local regions may be generated. Generation may be automatic (e.g., histogram based). The pixel values of the local region may be used to compile the histogram, and/or may generate the reshaping curve (e.g., generate the reshaping curve appropriately).

Generation may (e.g., may alternately) be based on input from a human content expert. For example, the expert may define the regions for which reshaping-equivalent operations may be performed. The expert may provide input to define the ‘reshaping curve’ that may be applied to such a region. The region partitioning may be arbitrarily defined by the human content expert, and/or there may be no requirement for the expert to provide reshaping curves for regions covering the image (e.g., the entire image). Areas with no reshaping curves defined may not be subject to the QP adjustment process.

The region-specific reshaping curves may be used to adjust the quantization parameters (e.g. delta QP values) for the CU's in the corresponding local regions (e.g., according to the technique performed for a global reshaping curve).

Hard partitions and/or separate histograms per partition may be used. A scrolling window analysis may be used. For example, for a CU (and/or for a local group of CUs), a histogram from a local region may be generated. The histogram from a local region may include the CU (and/or the CU's in the group) and/or a surrounding area (e.g. an N×N pixel area centered on the CU and/or CU group, and/or an area of M×M blocks surrounding the CU and/or CU group). A reshaping curve may be generated for this region based on the local-area histogram. The reshaping curve may be used to adjust the quantization parameters (e.g. delta QP values) for the CU, and/or the CU's in the group of CU's. These steps may be repeated at the next CU (and/or the next group of CU's), and so on (e.g., until QP adjustment has been performed for all CU's (and/or all relevant CU's) in the current picture).

Region-based adaptive reshaping may be performed using a global reshaping function. If the global reshaping function is signaled, it may be designed based on the sample value distribution (e.g., taken across the whole picture) and/or its impact upon subjective quality. For example, a histogram of luminance and/or the characteristics of the scene (e.g., bright/dark) may be considered in the global reshaping function design (e.g., region-based adaption and/or region-specific reshaping curves may be supported). As described herein, the effect of reshaping may be achieved by the quantization parameter adjustment with Equation (34). Combining an explicitly sent global reshaping function and the region-based quantization parameter adjustment together may achieve region based adaptive reshaping, e.g., because the quantization parameter may be signaled at the CU level, which is in a fine granularity. Moreover, if the global reshaping function is chosen appropriately, then the QP adjustments for (e.g., required for) the equivalent reshaping of individual regions may be reduced, and/or the cost to represent these QP adjustments may be lowered.

For example, a picture may be partitioned into N regions: {P₀, P₁, . . . , P_{N-1}} (e.g., as shown in FIG. 17). The desired reshaping function for i-th region may be denoted as rᵢ(x). The set of desired reshaping functions for region based reshaping may be {r₀(x), r₁(x), . . . , r_{N-1}(x)}. x may be the signal before reshaping. The global reshaping function for the whole picture may be denoted as r_{g}(x). Parameter r_{g}(x) may be explicitly signaled and sent in the bitstream. The derivation of QP for each CU may be performed. For example, if the CU belongs to k-th region, and/or the slice level QP is QP (e.g., when the region based reshaping is applied), the equivalent QP for the CU may be calculated as QP_{CU}(region), as noted in Equation (37):

QP_{CU}(region)=QP−6 log(r′ₖ(x)) (37)

When global reshaping (e.g., using an explicitly signaled global reshaping function) is applied, the equivalent QP for the CU may be calculated as QP_{CU}(global), as noted in Equation (38):

QP_{CU}(global)QP−6 log(r′ₖ(x)) (38)

If the global reshaping function and/or the delta QP (dQP) (e.g., for the CU to achieve the QP value calculated in Equation (37)) are (e.g., are both) signaled, then it may be equivalent to applying the region based reshaping function. In this way, region based adaptive reshaping may be provided, as noted in Equations (39) and (40).

QP_{CU}(global)+dQP=QP_{CU}(region) (39)

dQP may be derived as:

$$\begin{matrix}dQP = {QP}_{CU} ( region ) - {QP}_{CU} ( global ) \\ = - 6 log ( {r}^{′} k ( x ) ) + 6 log ( {r}^{′} g ( x ) )\end{matrix} \qquad ( 40 )$$

The slope of the reshaping function for the CU may be calculated (e.g., may be calculated in various ways). For example, the slope of the reshaping function for the CU may be calculated by using the average sample value of the CU as x. The slope of the reshaping function for the CU may be calculated by determining the slope for each sample within the CU (e.g., within the CU separately), and/or averaging those slopes (e.g., wherein the average of the slopes may be used for the slope of the reshaping function for the CU).

Region based adaptive reshaping may be achieved by one or more of signaling the reshaping function at picture level. For example, region based adaptive reshaping may be achieved by one or more of signaling the reshaping function at picture level as a global reshaping function (e.g., without requiring changes to procedures for forwarding reshaping before encoding and/or inverse reshaping after decoding); and signaling the dQP for each CU calculated as Equation (40) to achieve the equivalent region based reshaping function. The QP values may be adjusted at the encoder within the encoding loop and/or at the decoder, based on these dQP values.

It may not be necessary to signal multiple region based reshaping functions. Signaling overhead may be reduced. The application of the global reshaping function may reduce the magnitude and/or frequency of the individual CU-based QP adjustments, and/or the cost to achieve region-based reshaping may be reduced further.

The appropriate global and/or local reshaping functions as input may be obtained through various techniques. For example, the partitioning into local regions may be performed, and/or the local reshaping curves may be generated and/or obtained for each local region. The local reshaping curves may be computed automatically based on histograms of the local regions, and/or may be designed using human input). The local reshaping curves may be averaged together to obtain a global reshaping curve, which may be signaled (e.g., explicitly signaled) in the bitstream. The averaging may be pointwise averaging performed across the set (e.g., full set) of local reshaping curves. The averaging may be a weighted average, where the weights may be based on the relative sizes (and/or number of pixels) in local regions (e.g., the corresponding local regions).

The partitioning into regions (e.g., local regions) may be performed. The global reshaping function may be computed (e.g., computed automatically) based on a global histogram taken over the picture (e.g., full picture). The global reshaping function may be signaled (e.g., explicitly signaled) in the bitstream. Global forward reshaping may be applied (e.g., applied before encoding) and global inverse reshaping may be applied (e.g., applied after decoding). The desired local reshaping functions for each local region may be computed (e.g., computed automatically) based on a local histograms taken over that region. The QP adjustments for the CU's in each local region may be computed based on the local reshaping function for that region (e.g., using Equation (40)).

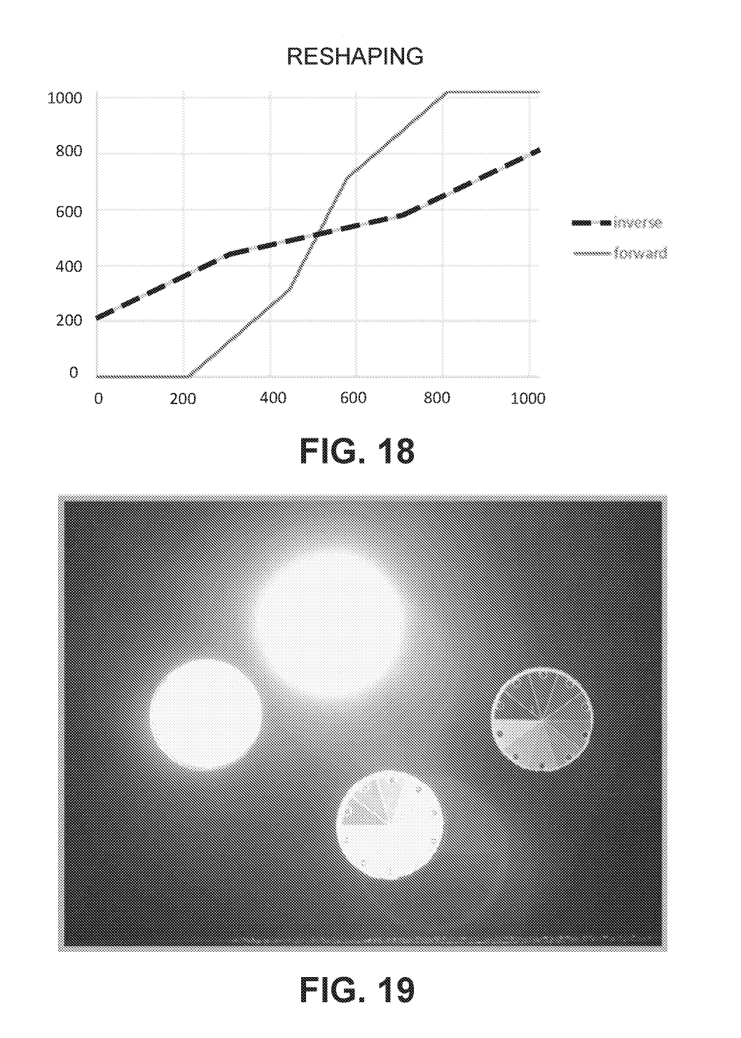

A nonlinear chroma reshaper may be implemented. Chroma artifacts may be seen in neutral areas of content. The reshaper may allow quantization (e.g., effective quantization) to be based on the chroma level (e.g., not just color plane and/or spatial region). To address chroma artifacts near neutral areas (e.g., chroma level 512 of 1023), a nonlinear chroma reshaper may be designed giving a high slope (e.g., near neutral) and/or a reduced slope (e.g., away from neutral). Effective quantization near neutral colors may be reduced, avoiding artifacts while the cost of using fine quantization for the chroma values may be lowered by adjusting quantization (e.g., an effectively coarser quantization) away from neutral values. FIG. 18 illustrates an example of this nonlinear reshaping.

A glare model may be implemented. In HDR imaging, limitations may be found in the ability to perceive changes (e.g., large changes) in dynamic range over distances. For example, in HDR imaging, limitations may be found in the ability to perceive changes in dynamic range over small spatial distances. Light scattered from areas (e.g., neighboring bright areas) may remove the ability to see dark detail. For example, light scattered from areas may remove the ability to see dark detail, similar to the problem faced with light pollution (e.g., the light pollution problem faced by astronomers). In a light pollution example, the range of visible details of a dark night sky may be masked by light from nearby sources scattered from the atmosphere. In the light pollution example, the additional light sources may be undesired and/or efforts may be made to curtail the impact of light pollution on astronomical observations. In HDR imaging, the bright light source may be desired and/or may not be eliminated.

An image format may support carrying a range (e.g., a large dynamic range). For example, a computer generated image may have pixels (e.g., dark pixels) with zero luminance next to a region of extreme brightness (e.g., 1000 cd/m2 luminance). The visibility of such extreme dynamic range may be reduced. For example, the visibility of such extreme dynamic range may be reduced due to the scattering of light from a region (e.g., a bright region) inside the image production device and/or the eye of the viewer. FIG. 19 shows an example where the detail visible in each disk may be reduced as the brightness of the disk may be increased.

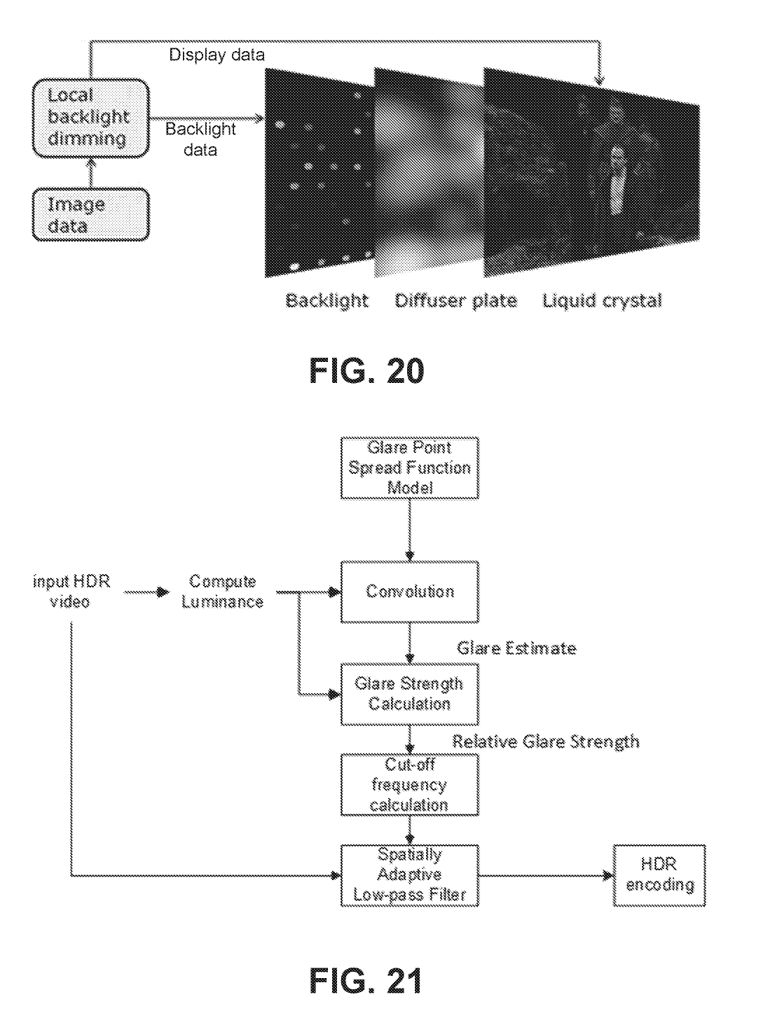

Some display technologies for HDR may exhibit light bleeding and/or glare. Some display technologies for HDR may be incapable of reproducing frequency (e.g., high spatial frequency) at a range (e.g., high dynamic range). FIG. 20 illustrates an example dual layer LCD that may have a spatial array of LEDs and/or a LCD layer. The dual layer LCD may be used to produce an HDR display. In a dual layer LCD, a conventional LCD panel with a 1000:1 contrast ratio may be combined with a backlight consisting of a spatial array of LEDS. The achievable dynamic range of the display may be a product of the native LCD contrast ratio (e.g., 1000:1) and/or the dynamic range achievable by spatial modulation of the LED array. An individual LED may be shut off (e.g., theoretically giving an infinite contrast ratio). In operation, the light pollution from neighboring LEDs may reduce the contrast (e.g., achievable contrast) in imaging (e.g., practical imaging). Typical products may use a high resolution LCD. For example, typical products may use a high resolution LCD combined with millions of pixels and/or backlight array with hundreds (or thousands) of LEDs. The ability of the display to reproduce the dark end of the dynamic range may be limited by light pollution. For example, the ability of the display to reproduce the dark end of the dynamic range may be limited by light pollution due to glare from neighboring bright areas.

An encoding system may not transmit data (e.g., may desirably not transmit data) that may not be perceived by the viewer. For example, an encoding system may not transmit data that may not be perceived by the viewer, given limits on the ability of a viewer to perceive dark regions. Limits on the ability of a viewer to perceive dark regions may be due to glare caused by light scattering in the eye and/or glare in the display system. A glare model may be used to control processing of an image. For example, a glare model may be used to control processing of an image prior to compression. This preprocessing stage may remove spatial detail when the influence of glare is high. FIG. 21 illustrates an example of using a glare model in preprocessing for HDR compression. For example, the relative glare strength may control a spatial adaptive low-pass filter. Additional methods (e.g., a bilateral filter) may be used to process the image prior to compression.

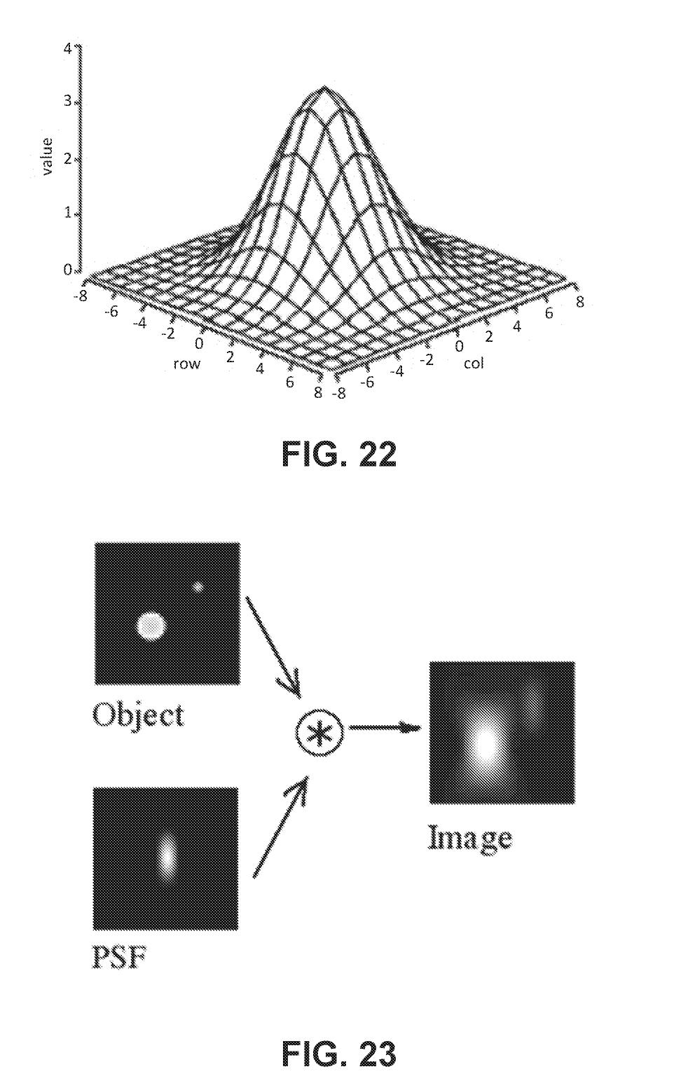

A model of the glare introduced by an image pixel may be represented through a point spread function. The image glare estimate may be computed by convolving a glare point spread function with the original image. This point spread function may be modeled as an isotopic Gaussian filter. For example, the point spread function may be modeled as an isotopic Gaussian filter with parameters width (W) and/or gain (g), as in Equation (41) described herein. An example Gaussian filter for modeling glare point spread function is shown in FIG. 22. The values W and/or g may be adjusted. For example, the values W and/or g may be adjusted based on the characteristics of the target display technology and/or human viewer. For example, W may be increased and/or decreased if the extent of the expected light spread is higher or lower, respectively. The extent of the expected light spread may be higher if the target display technology has a less dense arrangement of backlight LEDs. The extent of the expected light spread may be lower if the target display technology has a more dense arrangement of backlight LEDs. For example, g may be set higher if the expected intensity of light bleeding is larger, which may be related to the light blocking properties of the LCD panel. For example, W and g may be adjusted to account for internal glare properties of the human visual system. This may be adapted based on the age of the viewer. For example, W and/or g may be increased with the viewer's age. W and/or g may be increased with the viewer's age to account for increasing glare due to age-related clouding of the natural accommodative lens. Equation (41) describes a point spread function.

$$PSF ( x , y ) = g \cdot {exp}^{( \frac{{x}^{2} + {y}^{2}}{{W}^{2}} )} \qquad ( 41 )$$

Given an image, a glare estimate may be determined by convolving the modeled glare point spread function with the image luminance. FIG. 23 illustrates an example of convolution of a modeled glare point spread function with image luminance. This may result in a glare estimate determined by a convolution of the image luminance and/or the point spread function performed in Equation (42).

GlareEstimate(x,y)=(PSF*image)(x,y) (42)

The relative glare strength may be computed. For example, the relative glare strength may be computed at each pixel. The relative glare strength may be computed as the ratio of the glare estimate to the (local) image luminance value, as performed in Equation (43).

RelativeGlareStrength(x,y)=GlareEstimate(x,y)/image(x,y) (43)

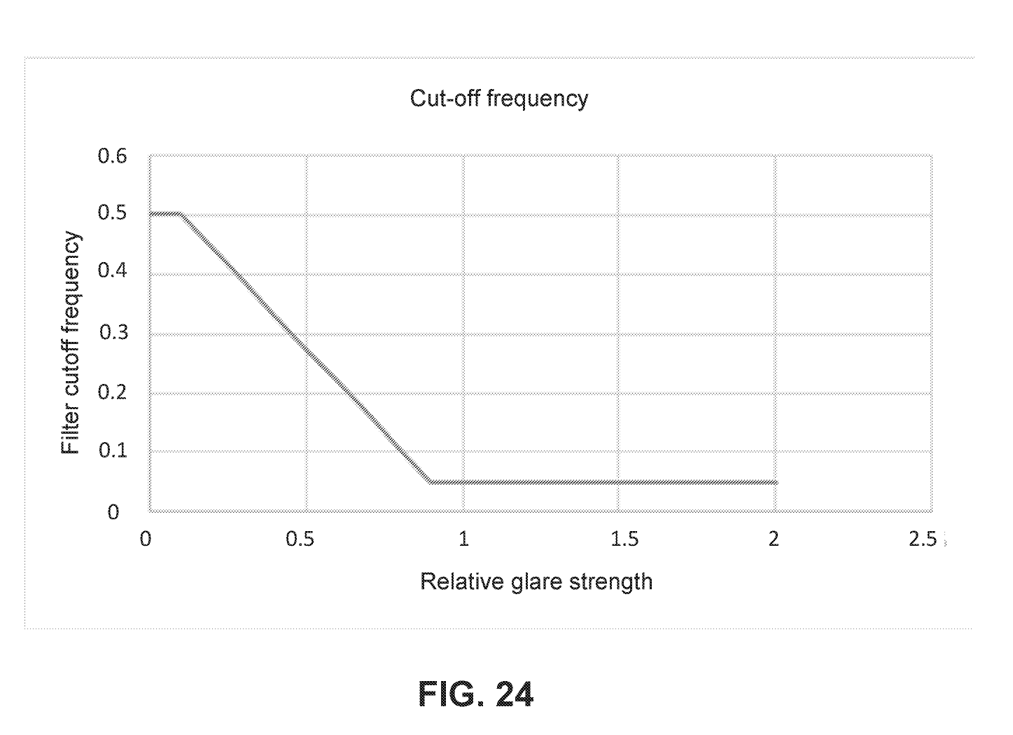

The cut-off frequency of a low-pass filter may be determined. For example, the cut-off frequency of a low-pass filter may be determined at each pixel position. For example, at each pixel position, the cut-off frequency of a low-pass filter may be determined based on the relative glare strength. FIG. 24 illustrates an example of filter cut-off frequency versus relative glare strength. At low relative glare strength (e.g., near 0), the cut-off frequency may be the 0.5, Nyquist sampling frequency, which may correspond to an all-pass filter which may not modify the image. For relative glare strength near and/or above 1, the cut-off frequency may be lower. The lower cut-off frequency may allow filtering to remove detail. The cut-off frequency may be continuous and may decrease for intermediate values of the relative glare strength.

The input image may be modified by applying the spatial filter. The modified image may be passed to the HDR encoder. The glare model may be relevant when relative glare strength is large. For example, the glare model may be relevant when relative glare strength exceeds 1. For standard dynamic range content, the glare model may have no effect because the values of the glare may fall below the minimum image value. The ratio may be less than one at the pixels and/or the filter may revert to an all-pass filter at the pixels.

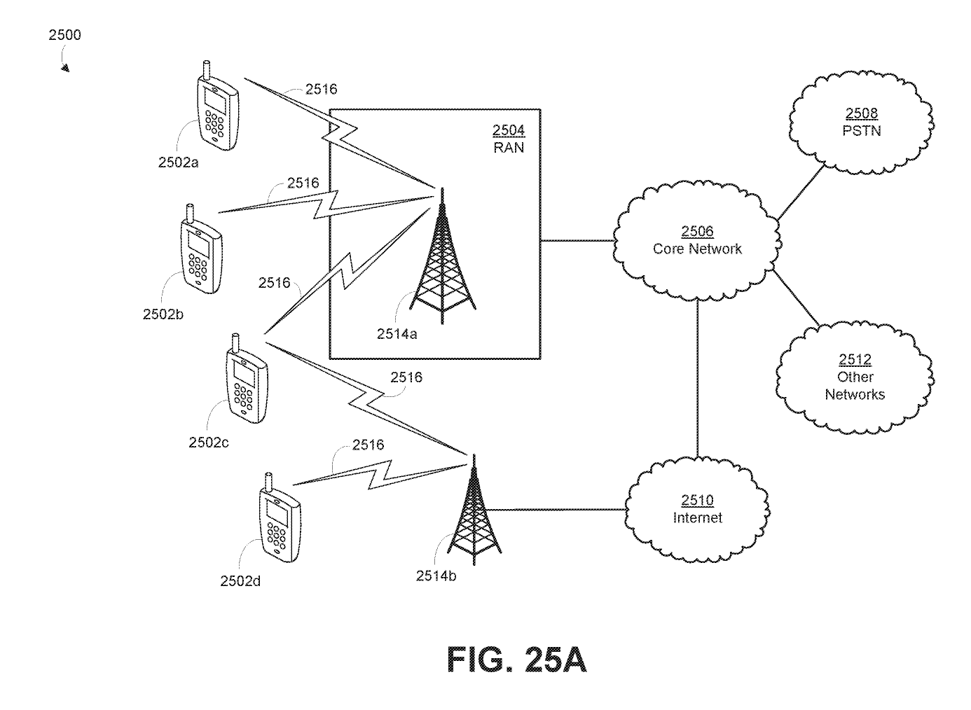

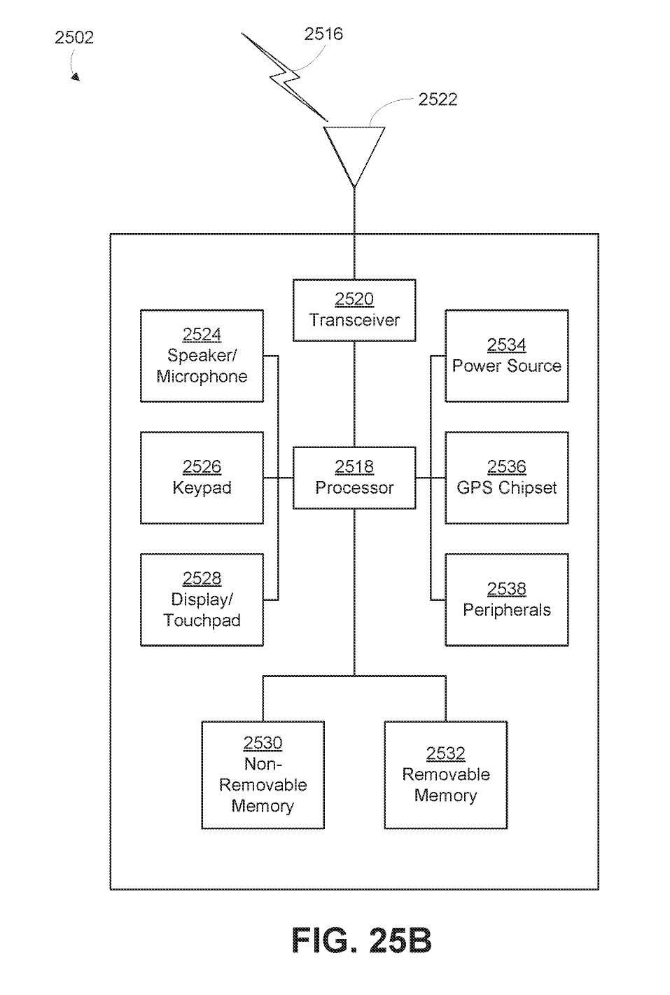

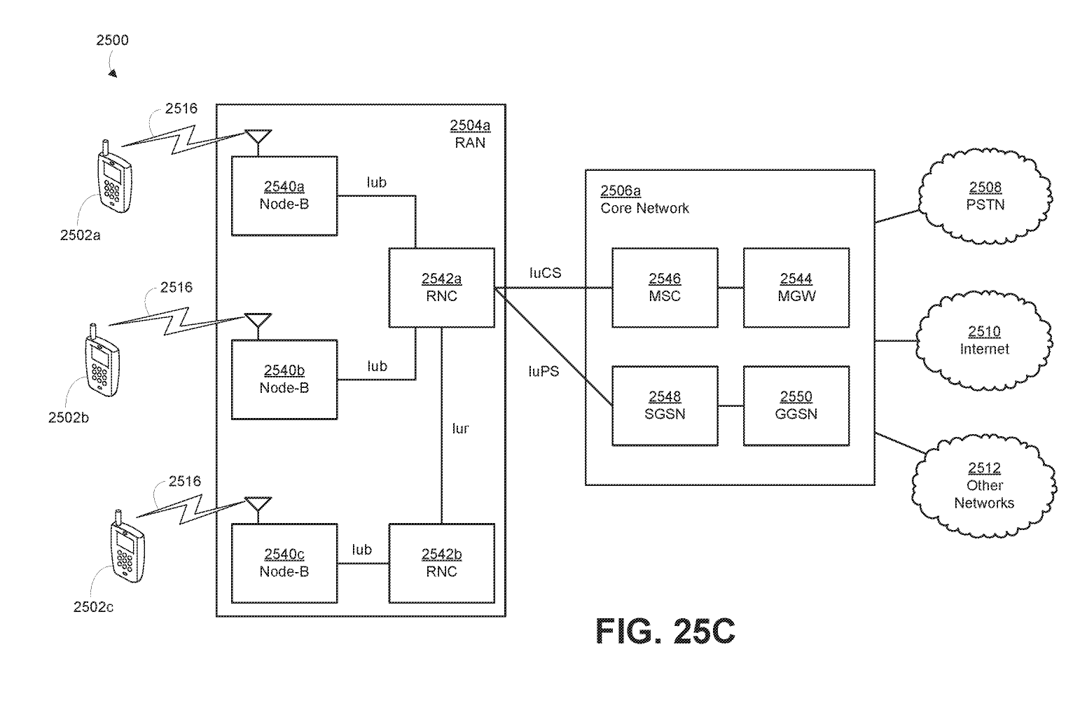

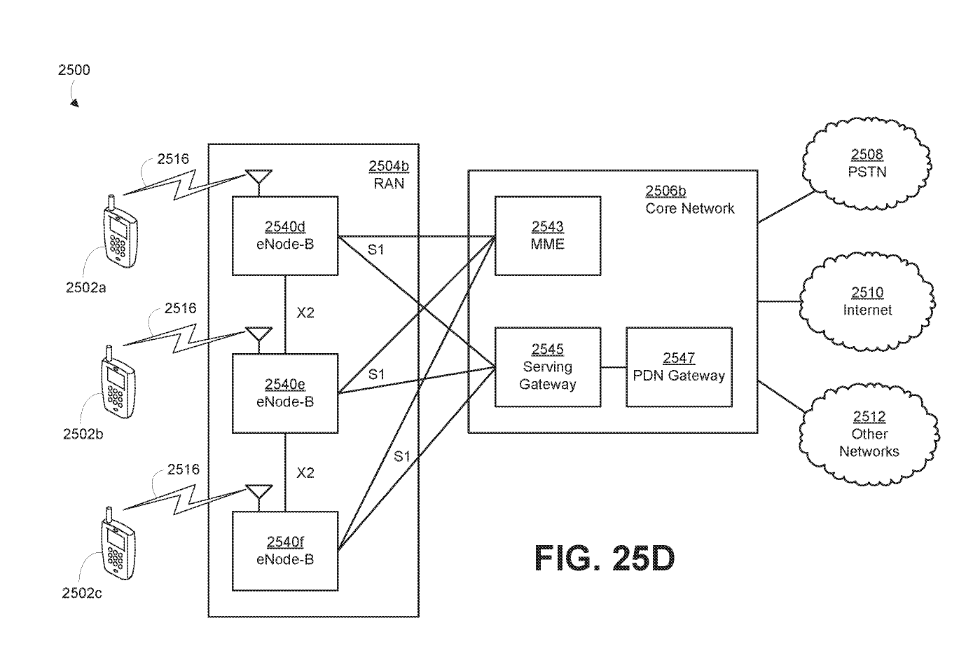

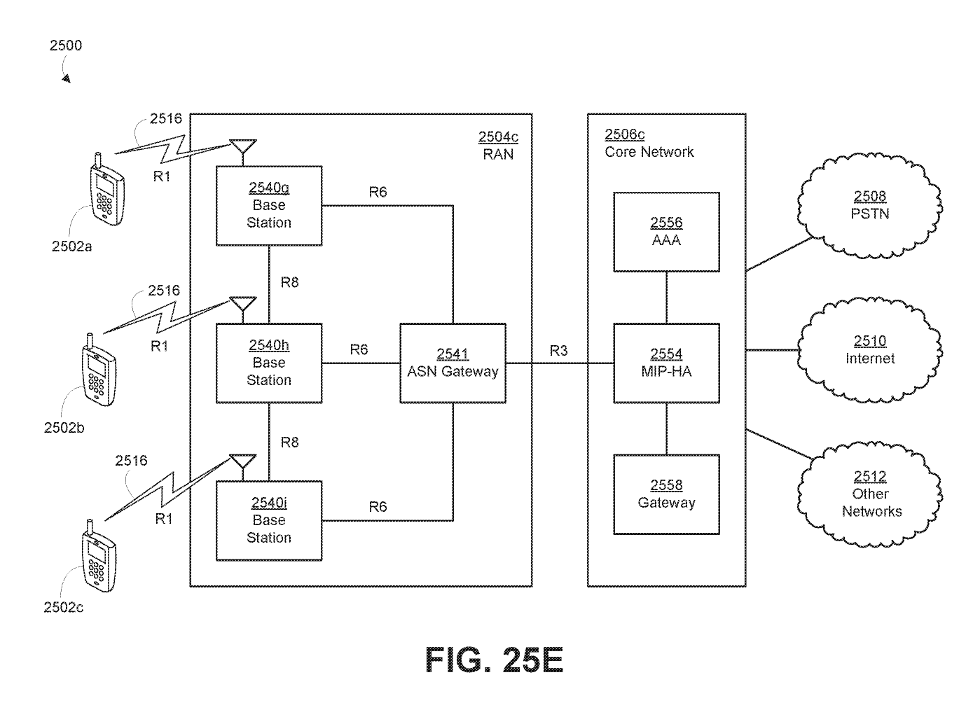

FIG. 25A is a diagram of an example communications system 2500 in which one or more disclosed embodiments may be implemented. The communications system 2500 may be a multiple access system that provides content, such as voice, data, video, messaging, broadcast, etc., to multiple wireless users. The communications system 2500 may enable multiple wireless users to access such content through the sharing of system resources, including wireless bandwidth. For example, the communications systems 2500 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 25A, the communications system 2500 may include wireless transmit/receive units (WTRUs) 2502a, 2502b, 2502c, and/or 2502d (which generally or collectively may be referred to as WTRU 2502), a radio access network (RAN) 2503/2504/2505, a core network 2506/2507/2509, a public switched telephone network (PSTN) 2508, the Internet 2510, and other networks 2512, though it will be appreciated that the disclosed embodiments contemplate any number of WTRUs, base stations, networks, and/or network elements. Each of the WTRUs 2502a, 2502b, 2502c, 2502d may be any type of device configured to operate and/or communicate in a wireless environment. By way of example, the WTRUs 2502a, 2502b, 2502c, 2502d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 2500 may also include a base station 2514a and a base station 2514b. Each of the base stations 2514a, 2514b may be any type of device configured to wirelessly interface with at least one of the WTRUs 2502a, 2502b, 2502c, 2502d to facilitate access to one or more communication networks, such as the core network 2506/2507/2509, the Internet 2510, and/or the networks 2512. By way of example, the base stations 2514a. 2514b may be a base transceiver station (BTS), a Node-B, an eNode B, a Home Node B, a Home eNode B, a site controller, an access point (AP), a wireless router, and the like. While the base stations 2514a, 2514b are each depicted as a single element, it will be appreciated that the base stations 2514a, 2514b may include any number of interconnected base stations and/or network elements.

The base station 2514a may be part of the RAN 2503/2504/2505, which may also include other base stations and/or network elements (not shown), such as a base station controller (BSC), a radio network controller (RNC), relay nodes, etc. The base station 2514a and/or the base station 2514b may be configured to transmit and/or receive wireless signals within a particular geographic region, which may be referred to as a cell (not shown). The cell may further be divided into cell sectors. For example, the cell associated with the base station 2514a may be divided into three sectors. Thus, in one embodiment, the base station 2514a may include three transceivers, e.g., one for each sector of the cell. In another embodiment, the base station 2514a may employ multiple-input multiple output (MIMO) technology and, therefore, may utilize multiple transceivers for each sector of the cell.

The base stations 2514a, 2514b may communicate with one or more of the WTRUs 2502a, 2502b, 2502c, 2502d over an air interface 2515/2516/2517, which may be any suitable wireless communication link (e.g., radio frequency (RF), microwave, infrared (IR), ultraviolet (UV), visible light, etc.). The air interface 2515/2516/2517 may be established using any suitable radio access technology (RAT).

More specifically, as noted above, the communications system 2500 may be a multiple access system and may employ one or more channel access schemes, such as CDMA, TDMA, FDMA. OFDMA, SC-FDMA, and the like. For example, the base station 2514a in the RAN 2503/2504/2505 and the WTRUs 2502a, 2502b, 2502c may implement a radio technology such as Universal Mobile Telecommunications System (UMTS) Terrestrial Radio Access (UTRA), which may establish the air interface 2515/2516/2517 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 2514a and the WTRUs 2502a, 2502b, 2502c may implement a radio technology such as Evolved UMTS Terrestrial Radio Access (E-UTRA), which may establish the air interface 2515/2516/2517 using Long Term Evolution (LTE) and/or LTE-Advanced (LTE-A).

In other embodiments, the base station 2514a and the WTRUs 2502a, 2502b, 2502c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 2514b in FIG. 25A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 2514b and the WTRUs 2502c, 2502d may implement a radio technology such as IEEE 802.11 to establish a wireless local area network (WLAN). In another embodiment, the base station 2514b and the WTRUs 2502c, 2502d may implement a radio technology such as IEEE 802.15 to establish a wireless personal area network (WPAN). In yet another embodiment, the base station 2514b and the WTRUs 2502c, 2502d may utilize a cellular-based RAT (e.g., WCDMA, CDMA2000, GSM, LTE, LTE-A, etc.) to establish a picocell or femtocell. As shown in FIG. 25A, the base station 2514b may have a direct connection to the Internet 2510. Thus, the base station 2514b may not be required to access the Internet 2510 via the core network 2506/2507/2509.

The RAN 2503/2504/2505 may be in communication with the core network 2506/2507/2509, which may be any type of network configured to provide voice, data, applications, and/or voice over internet protocol (VoIP) services to one or more of the WTRUs 2502a, 2502b, 2502c, 2502d. For example, the core network 2506/2507/2509 may provide call control, billing services, mobile location-based services, pre-paid calling, Internet connectivity, video distribution, etc., and/or perform high-level security functions, such as user authentication. Although not shown in FIG. 25A, it will be appreciated that the RAN 2503/2504/2505 and/or the core network 2506/2507/2509 may be in direct or indirect communication with other RANs that employ the same RAT as the RAN 2503/2504/2505 or a different RAT. For example, in addition to being connected to the RAN 2503/2504/2505, which may be utilizing an E-UTRA radio technology, the core network 2506/2507/2509 may also be in communication with another RAN (not shown) employing a GSM radio technology.

The core network 2506/2507/2509 may also serve as a gateway for the WTRUs 2502a, 2502b, 2502c, 2502d to access the PSTN 2508, the Internet 2510, and/or other networks 2512. The PSTN 2508 may include circuit-switched telephone networks that provide plain old telephone service (POTS). The Internet 2510 may include a global system of interconnected computer networks and devices that use common communication protocols, such as the transmission control protocol (TCP), user datagram protocol (UDP) and the internet protocol (IP) in the TCP/IP internet protocol suite. The networks 2512 may include wired or wireless communications networks owned and/or operated by other service providers. For example, the networks 2512 may include another core network connected to one or more RANs, which may employ the same RAT as the RAN 2503/2504/2505 or a different RAT.

Some or all of the WTRUs 2502a, 2502b, 2502c, 2502d in the communications system 2500 may include multi-mode capabilities, i.e., the WTRUs 2502a, 2502b, 2502c, 2502d may include multiple transceivers for communicating with different wireless networks over different wireless links. For example, the WTRU 2502c shown in FIG. 25A may be configured to communicate with the base station 2514a, which may employ a cellular-based radio technology, and with the base station 2514b, which may employ an IEEE 802 radio technology.

FIG. 25B is a system diagram of an example WTRU 2502. As shown in FIG. 25B, the WTRU 2502 may include a processor 2518, a transceiver 2520, a transmit/receive element 2522, a speaker/microphone 2524, a keypad 2526, a display/touchpad 2528, non-removable memory 2530, removable memory 2532, a power source 2534, a global positioning system (GPS) chipset 2536, and other peripherals 2538. It will be appreciated that the WTRU 2502 may include any sub-combination of the foregoing elements while remaining consistent with an embodiment. Also, embodiments contemplate that the base stations 2514a and 2514b, and/or the nodes that base stations 2514a and 2514b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 25B and described herein.

The processor 2518 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 2518 may perform signal coding, data processing, power control, input/output processing, and/or any other functionality that enables the WTRU 2502 to operate in a wireless environment. The processor 2518 may be coupled to the transceiver 2520, which may be coupled to the transmit/receive element 2522. While FIG. 25B depicts the processor 2518 and the transceiver 2520 as separate components, it will be appreciated that the processor 2518 and the transceiver 2520 may be integrated together in an electronic package or chip.

The transmit/receive element 2522 may be configured to transmit signals to, or receive signals from, a base station (e.g., the base station 2514a) over the air interface 2515/2516/2517. For example, in one embodiment, the transmit/receive element 2522 may be an antenna configured to transmit and/or receive RF signals. In another embodiment, the transmit/receive element 2522 may be an emitter/detector configured to transmit and/or receive IR UV, or visible light signals, for example. In yet another embodiment, the transmit/receive element 2522 may be configured to transmit and receive both RF and light signals. It will be appreciated that the transmit/receive element 2522 may be configured to transmit and/or receive any combination of wireless signals.

In addition, although the transmit/receive element 2522 is depicted in FIG. 25B as a single element, the WTRU 2502 may include any number of transmit/receive elements 2522. More specifically, the WTRU 2502 may employ MIMO technology. Thus, in one embodiment, the WTRU 2502 may include two or more transmit/receive elements 2522 (e.g., multiple antennas) for transmitting and receiving wireless signals over the air interface 2515/2516/2517.

The transceiver 2520 may be configured to modulate the signals that are to be transmitted by the transmit/receive element 2522 and to demodulate the signals that are received by the transmit/receive element 2522. As noted above, the WTRU 2502 may have multi-mode capabilities. Thus, the transceiver 2520 may include multiple transceivers for enabling the WTRU 2502 to communicate via multiple RATs, such as UTRA and IEEE 802.11, for example.

The processor 2518 of the WTRU 2502 may be coupled to, and may receive user input data from, the speaker/microphone 2524, the keypad 2526, and/or the display/touchpad 2528 (e.g., a liquid crystal display (LCD) display unit or organic light-emitting diode (OLED) display unit). The processor 2518 may also output user data to the speaker/microphone 2524, the keypad 2526, and/or the display/touchpad 2528. In addition, the processor 2518 may access information from, and store data in, any type of suitable memory, such as the non-removable memory 2530 and/or the removable memory 2532. The non-removable memory 2530 may include random-access memory (RAM), read-only memory (ROM), a hard disk, or any other type of memory storage device. The removable memory 2532 may include a subscriber identity module (SIM) card, a memory stick, a secure digital (SD) memory card, and the like. In other embodiments, the processor 2518 may access information from, and store data in, memory that is not physically located on the WTRU 2502, such as on a server or a home computer (not shown).

The processor 2518 may receive power from the power source 2534, and may be configured to distribute and/or control the power to the other components in the WTRU 2502. The power source 2534 may be any suitable device for powering the WTRU 2502. For example, the power source 2534 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 2518 may also be coupled to the GPS chipset 2536, which may be configured to provide location information (e.g., longitude and latitude) regarding the current location of the WTRU 2502. In addition to, or in lieu of, the information from the GPS chipset 2536, the WTRU 2502 may receive location information over the air interface 2515/2516/2517 from a base station (e.g., base stations 2514a, 2514b) and/or determine its location based on the timing of the signals being received from two or more nearby base stations. It will be appreciated that the WTRU 2502 may acquire location information by way of any suitable location-determination method while remaining consistent with an embodiment.

The processor 2518 may further be coupled to other peripherals 2538, which may include one or more software and/or hardware modules that provide additional features, functionality and/or wired or wireless connectivity. For example, the peripherals 2538 may include an accelerometer, an c-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 25C is a system diagram of the RAN 2503 and the core network 2506 according to an embodiment. As noted above, the RAN 2503 may employ a UTRA radio technology to communicate with the WTRUs 2502a, 2502b, 2502c over the air interface 2515. The RAN 2503 may also be in communication with the core network 2506. As shown in FIG. 25C, the RAN 2503 may include Node-Bs 2540a. 2540b, 2540c, which may each include one or more transceivers for communicating with the WTRUs 2502a, 2502b, 2502c over the air interface 2515. The Node-Bs 2540a, 2540b, 2540c may each be associated with a particular cell (not shown) within the RAN 2503. The RAN 2503 may also include RNCs 2542a, 2542b. It will be appreciated that the RAN 2503 may include any number of Node-Bs and RNCs while remaining consistent with an embodiment.

As shown in FIG. 25C, the Node-Bs 2540a, 2540b may be in communication with the RNC 2542a. Additionally, the Node-B 2540c may be in communication with the RNC 142b. The Node-Bs 2540a. 2540b, 2540c may communicate with the respective RNCs 2542a. 2542b via an Iub interface. The RNCs 2542a. 2542b may be in communication with one another via an Iur interface. Each of the RNCs 2542a, 2542b may be configured to control the respective Node-Bs 2540a, 2540b. 2540c to which it is connected. In addition, each of the RNCs 2542a, 2542b may be configured to carry out or support other functionality, such as outer loop power control, load control, admission control, packet scheduling, handover control, macrodiversity, security functions, data encryption, and the like.

The core network 2506 shown in FIG. 25C may include a media gateway (MGW) 2544, a mobile switching center (MSC) 2546, a serving GPRS support node (SGSN) 2548, and/or a gateway GPRS support node (GGSN) 2550. While each of the foregoing elements are depicted as part of the core network 2506, it will be appreciated that any one of these elements may be owned and/or operated by an entity other than the core network operator.

The RNC 2542a in the RAN 2503 may be connected to the MSC 2546 in the core network 2506 via an IuCS interface. The MSC 2546 may be connected to the MGW 2544. The MSC 2546 and the MGW 2544 may provide the WTRUs 2502a, 2502b, 2502c with access to circuit-switched networks, such as the PSTN 2508, to facilitate communications between the WTRUs 2502a, 2502b, 2502c and traditional land-line communications devices.

The RNC 2542a in the RAN 2503 may also be connected to the SGSN 2548 in the core network 2506 via an IuPS interface. The SGSN 2548 may be connected to the GGSN 2550. The SGSN 2548 and the GGSN 2550 may provide the WTRUs 2502a, 2502b, 2502c with access to packet-switched networks, such as the Internet 2510, to facilitate communications between and the WTRUs 2502a, 2502b, 2502c and IP-enabled devices.

As noted above, the core network 2506 may also be connected to the networks 2512, which may include other wired or wireless networks that are owned and/or operated by other service providers.

FIG. 25D is a system diagram of the RAN 2504 and the core network 2507 according to an embodiment. As noted above, the RAN 2504 may employ an E-UTRA radio technology to communicate with the WTRUs 2502a, 2502b, 2502c over the air interface 2516. The RAN 2504 may also be in communication with the core network 2507.

The RAN 2504 may include eNode-Bs 2560a, 2560b, 2560c, though it will be appreciated that the RAN 2504 may include any number of eNode-Bs while remaining consistent with an embodiment. The eNode-Bs 2560a, 2560b, 2560c may each include one or more transceivers for communicating with the WTRUs 2502a, 2502b, 2502c over the air interface 2516. In one embodiment, the eNode-Bs 2560a, 2560b, 2560c may implement MIMO technology. Thus, the eNode-B 2560a, for example, may use multiple antennas to transmit wireless signals to, and receive wireless signals from, the WTRU 2502a.

Each of the eNode-Bs 2560a. 2560b, 2560c may be associated with a particular cell (not shown) and may be configured to handle radio resource management decisions, handover decisions, scheduling of users in the uplink and/or downlink, and the like. As shown in FIG. 25D, the eNode-Bs 2560a, 2560b, 2560c may communicate with one another over an X2 interface.

The core network 2507 shown in FIG. 25D may include a mobility management gateway (MME) 2562, a serving gateway 2564, and a packet data network (PDN) gateway 2566. While each of the foregoing elements are depicted as part of the core network 2507, it will be appreciated that any one of these elements may be owned and/or operated by an entity other than the core network operator.

The MME 2562 may be connected to each of the eNode-Bs 2560a, 2560b, 2560c in the RAN 2504 via an S1 interface and may serve as a control node. For example, the MME 2562 may be responsible for authenticating users of the WTRUs 2502a, 2502b, 2502c, bearer activation/deactivation, selecting a particular serving gateway during an initial attach of the WTRUs 2502a, 2502b, 2502c, and the like. The MME 2562 may also provide a control plane function for switching between the RAN 2504 and other RANs (not shown) that employ other radio technologies, such as GSM or WCDMA.

The serving gateway 2564 may be connected to each of the eNode-Bs 2560a. 2560b, 2560c in the RAN 2504 via the SI interface. The serving gateway 2564 may generally route and forward user data packets to/from the WTRUs 2502a, 2502b, 2502c. The serving gateway 2564 may also perform other functions, such as anchoring user planes during inter-eNode B handovers, triggering paging when downlink data is available for the WTRUs 2502a, 2502b. 2502c, managing and storing contexts of the WTRUs 2502a, 2502b, 2502c, and the like.

The serving gateway 2564 may also be connected to the PDN gateway 2566, which may provide the WTRUs 2502a, 2502b, 2502c with access to packet-switched networks, such as the Internet 2510, to facilitate communications between the WTRUs 2502a, 2502b, 2502c and IP-enabled devices.

The core network 2507 may facilitate communications with other networks. For example, the core network 2507 may provide the WTRUs 2502a, 2502b, 2502c with access to circuit-switched networks, such as the PSTN 2508, to facilitate communications between the WTRUs 2502a, 2502b, 2502c and traditional land-line communications devices. For example, the core network 2507 may include, or may communicate with, an IP gateway (e.g., an IP multimedia subsystem (IMS) server) that serves as an interface between the core network 2507 and the PSTN 2508. In addition, the core network 2507 may provide the WTRUs 2502a, 2502b, 2502c with access to the networks 2512, which may include other wired or wireless networks that are owned and/or operated by other service providers.

FIG. 25E is a system diagram of the RAN 2505 and the core network 2509 according to an embodiment. The RAN 2505 may be an access service network (ASN) that employs IEEE 802.16 radio technology to communicate with the WTRUs 2502a, 2502b, 2502c over the air interface 2517. As will be further discussed below, the communication links between the different functional entities of the WTRUs 2502a, 2502b, 2502c, the RAN 2505, and the core network 2509 may be defined as reference points.

As shown in FIG. 25E, the RAN 2505 may include base stations 2580a, 2580b, 2580c, and an ASN gateway 2582, though it will be appreciated that the RAN 2505 may include any number of base stations and ASN gateways while remaining consistent with an embodiment. The base stations 2580a, 2580b, 2580c may each be associated with a particular cell (not shown) in the RAN 2505 and may each include one or more transceivers for communicating with the WTRUs 2502a, 2502b, 2502c over the air interface 2517. In one embodiment, the base stations 2580a, 2580b, 2580c may implement MIMO technology. Thus, the base station 2580a, for example, may use multiple antennas to transmit wireless signals to, and receive wireless signals from, the WTRU 2502a. The base stations 2580a, 2580b, 2580c may also provide mobility management functions, such as handoff triggering, tunnel establishment, radio resource management, traffic classification, quality of service (QoS) policy enforcement, and the like. The ASN gateway 2582 may serve as a traffic aggregation point and may be responsible for paging, caching of subscriber profiles, routing to the core network 2509, and the like.

The air interface 2517 between the WTRUs 2502a, 2502b, 2502c and the RAN 2505 may be defined as an R1 reference point that implements the IEEE 802.16 specification. In addition, each of the WTRUs 2502a, 2502b, 2502c may establish a logical interface (not shown) with the core network 2509. The logical interface between the WTRUs 2502a, 2502b, 2502c and the core network 2509 may be defined as an R2 reference point, which may be used for authentication, authorization, IP host configuration management, and/or mobility management.

The communication link between each of the base stations 2580a, 2580b, 2580c may be defined as an R8 reference point that includes protocols for facilitating WTRU handovers and the transfer of data between base stations. The communication link between the base stations 2580a, 2580b, 2580c and the ASN gateway 2582 may be defined as an R6 reference point. The R6 reference point may include protocols for facilitating mobility management based on mobility events associated with each of the WTRUs 2502a, 2502b, 2502c.

As shown in FIG. 25E, the RAN 2505 may be connected to the core network 2509. The communication link between the RAN 2505 and the core network 2509 may defined as an R3 reference point that includes protocols for facilitating data transfer and mobility management capabilities, for example. The core network 2509 may include a mobile IP home agent (MIP-HA) 2584, an authentication, authorization, accounting (AAA) server 2586, and a gateway 2588. While each of the foregoing elements are depicted as part of the core network 2509, it will be appreciated that any one of these elements may be owned and/or operated by an entity other than the core network operator.

The MIP-HA may be responsible for IP address management, and may enable the WTRUs 2502a, 2502b, 2502c to roam between different ASNs and/or different core networks. The MIP-HA 2584 may provide the WTRUs 2502a, 2502b, 2502c with access to packet-switched networks, such as the Internet 2510, to facilitate communications between the WTRUs 2502a, 2502b, 2502c and IP-enabled devices. The AAA server 2586 may be responsible for user authentication and for supporting user services. The gateway 2588 may facilitate interworking with other networks. For example, the gateway 2588 may provide the WTRUs 2502a, 2502b, 2502c with access to circuit-switched networks, such as the PSTN 2508, to facilitate communications between the WTRUs 2502a, 2502b, 2502c and traditional land-line communications devices. In addition, the gateway 2588 may provide the WTRUs 2502a, 2502b, 2502c with access to the networks 2512, which may include other wired or wireless networks that are owned and/or operated by other service providers.

Although not shown in FIG. 25E, it will be appreciated that the RAN 2505 may be connected to other ASNs and the core network 2509 may be connected to other core networks. The communication link between the RAN 2505 the other ASNs may be defined as an R4 reference point, which may include protocols for coordinating the mobility of the WTRUs 2502a, 2502b, 2502c between the RAN 2505 and the other ASNs. The communication link between the core network 2509 and the other core networks may be defined as an R5 reference, which may include protocols for facilitating interworking between home core networks and visited core networks.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station. RNC, and/or any host computer.

1-18. (canceled)

19. A video coding device for encoding a video sequence, the device comprising:
a processor configured to:
receive the video sequence comprising a first-temporal level picture associated with a first temporal level and a second-temporal level picture associated with a second temporal level, wherein the second-temporal level picture references the first-temporal level picture for temporal prediction;
determine, based on a temporal level of the first-temporal level picture, a first chroma quantization parameter (QP) offset for the first-temporal level picture, wherein the first chroma QP offset is relative to a luma QP associated with the first-temporal level picture;
determine, based on a temporal level of the second-temporal level picture, a second chroma QP offset for the second-temporal level picture, wherein the second chroma QP offset is relative to a luma QP associated with the second-temporal level picture; and
encode the first-temporal level picture based on the first chroma QP offset and the second-temporal level picture based on the second chroma QP offset.

20. The video coding device of claim 19, wherein the video sequence is a high dynamic range (HDR) or wide color gamut (WCG) video sequence.

21. The video coding device of claim 19, wherein the first-temporal level picture has a better quality than the second-temporal level picture as a result of the first-temporal level picture using more coding bits than the second-temporal level picture.

22. The video coding device of claim 19, wherein the first chroma QP offset is smaller than the second chroma QP offset.

23. The video coding device of claim 19, wherein the processor is further configured to:
measure a chroma energy associated with the first-temporal level picture; and
determine whether to adjust the first chroma QP offset based on the measured chroma energy associated with the first-temporal level picture.

24. The video coding device of claim 23, wherein, on a condition that the chroma energy is larger than a predetermined chroma activity threshold:
determine an adjustment amount by comparing the chroma energy to a predetermined chroma energy threshold; and
calculate the first chroma QP offset by the determined adjustment amount.

25. The video coding device of claim 24, wherein the processor is further configured to:
signal the adjustment amount in at least one of a picture parameter set, a slice header, or a coding block.

26. The video coding device of claim 19, wherein the first-temporal level is a lower temporal level than the second-temporal level.

27. The video coding device of claim 19, wherein the processor is further configured to:
compute a first chroma QP based on the first chroma QP offset;
compute a second chroma QP based on the second chroma QP offset; and
encode the first-temporal level picture based on the first chroma QP and the second-temporal level picture based on the second chroma QP.

28. A video coding device for encoding a video sequence, the device comprising:
a processor configured to:
identify a first parameter (“beta”) value used to determine if deblocking filtering is to be performed, a second parameter (“t_{C}”) value used to determine an amplitude of a deblocking filter, a previous distortion, and a second previous distortion;
calculate a distortion associated with using the beta value and the t_{C} value for performing deblocking filtering;
compare the previous distortion with the second previous distortion; and
on a condition that the previous distortion is greater than the second previous distortion, signal the beta value and the t_{C} value as deblocking parameters.

29. The video coding device of claim 28, wherein on a condition that the previous distortion is less than the second previous distortion, the processor is further configured to:
identify a next beta value and a next t_{C} value; and
calculate a next distortion associated with using the next beta value and the next t_{C} value for performing deblocking filtering.

30. The video coding device of claim 28, wherein identifying the next beta value comprises decrementing the beta value by a predetermined step value.

31. The video coding device of claim 28, wherein:
on a condition that the previous distortion is less than the second previous distortion, the processor is further configured to:
identify a next beta value and a next t_{C} value; and
calculate a next distortion associated with using the next beta value and the next t_{C} value;
compare the next distortion with the distortion; and
on a condition that the next distortion is greater than the distortion, signal the beta value and the t_{C} value as the deblocking parameters.

32. The video coding device of claim 28, wherein the processor is further configured to:
determine a beta value search window based on a beta value selected for a previous picture in a same temporal level, wherein the beta value is identified within the beta value search window; and
determine a t_{C} value search window based on a t_{C} value selected for the previous picture in the same temporal level, wherein the t_{C} value is identified within the t_{C} value search window.

33. A method for encoding a video sequence, comprising:
receiving the video sequence comprising a first-temporal level picture associated with a first temporal level and a second-temporal level picture associated with a second temporal level, wherein the second-temporal level picture references the first-temporal level picture;
determining, based on a temporal level of the first-temporal level picture, a first chroma quantization parameter (QP) offset for the first-temporal level picture, wherein the first chroma QP offset is relative to a luma QP associated with the video sequence;
determining, based on a temporal level of the second-temporal level picture, a second chroma QP offset for the second-temporal level picture, wherein the second chroma QP offset is relative to the luma QP; and
encoding the first-temporal level picture based on the first chroma QP offset for the first-temporal level picture and the second-temporal level picture based on the second chroma QP offset for the second-temporal level picture.

34. The method of claim 33, wherein the first chroma QP offset is smaller than the second chroma QP offset.

35. The method of claim 33, further comprising:
measuring a chroma energy associated with the first-temporal level picture; and
determining whether to adjust the first chroma QP offset based on the measured chroma energy associated with the first-temporal level picture.

36. The method of claim 35, further comprising:
on a condition that the chroma energy is larger than a predetermined chroma activity threshold:
determining an adjustment amount by comparing the chroma energy to a predetermine chroma energy threshold; and
adjusting the first chroma QP offset by the determined adjustment amount.

37. The method of claim 33, wherein the first-temporal level is a lower temporal level than the second-temporal level.

38. The method of claim 33, further comprising:
computing a first chroma QP based on the first chroma QP offset;
computing a second chroma QP based on the second chroma QP offset; and
encoding the first-temporal level picture based on the first chroma QP and the second-temporal level picture based on the second chroma QP.
